(19) United States
(12) Patent Application Publication
(10) Pub. No.: US 2026/0181358 A1
(43) Pub. Date: Jun. 25, 2026

(54) SYSTEMS AND METHODS FOR WIRELESS CONFIGURATION OF IN-VEHICLE NETWORKS

(71) Applicant: QUALCOMM Incorporated, San Diego, CA (US)

(72) Inventors: Dan Vassilovski, Del Mar, CA (US); Nishant Gupta, Bangalore (IN); Hong Cheng, Basking Ridge, NJ (US)

(21) Appl. No.: 18/987,782

(22) Filed: Dec. 19, 2024

(51) Int. Cl. H04W 4/08; H04L 67/12

(52) U.S. Cl. CPC H04W 4/08; H04L 67/12

(57) ABSTRACT

This disclosure provides systems and methods for wireless communication that support enhanced in-vehicle network (IVN) configuration operations. In a first aspect, a vehicle includes a plurality of IVNs of an IVN system with a plurality of sensors and a plurality of electronic control units (ECUs), at least one processor, and a memory coupled to the at least one processor. The at least one processor is configured to cause the vehicle to: obtain IVN configuration information corresponding to a particular IVN system configuration; configure one or more sensors of the plurality of sensors, one or more ECUs of the plurality of ECUs, or both, for unicast and groupcast wireless communications based on the IVN configuration information; and wirelessly transmit via the one or more sensors or the one or more ECUs using the particular IVN system configuration. Other aspects and features are also claimed and described.

### TECHNICAL FIELD

Aspects of the present disclosure relate generally to wireless communication systems, and more particularly, to flexible and dynamic configuration of wireless networks. Some features may enable and provide improved network configuration and reconfiguration operations, including improved in-vehicle network (IVN) configuration and reconfiguration operations.

### INTRODUCTION

Vehicles include an in-vehicle network (IVN) system to enable communications across the devices of the vehicles such as ECUs, sensors, etc. In order to provide such communication operations, vehicles include a plurality of disparate wired networks, including Controller Area Network (CAN), FlexRay, Local Interconnect Network (LIN), Media Oriented Systems Transport (MOST), low-voltage differential signaling (LVDS), Ethernet, etc., each an IVN. In many vehicles, multiple, overlapping wired networks of the same technology are present (e.g., multiple CAN bus networks for different sensor/ECU sub-groups). The entire IVN system may include up to several kilometers of wiring, and in larger vehicles these wired networks can add over 100 lbs. to the weight of the vehicle. The wired networks contribute significantly to vehicle complexity, cost, and fuel efficiency. Vehicle manufacturers have begun to explore using wireless networks to replacement for vehicle wired networks to simplify vehicle design and to reduce weight and costs. However, the design, configuration, and management of such complex wireless networks has posed many challenges to adoption of wireless communications for IVNs.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a vehicle includes a plurality of sensors, a plurality of electronic control units (ECUs), wherein the plurality of sensors and the plurality of ECUs correspond to a plurality of in-vehicle networks (IVNs) of an IVN system, at least one processor, and a memory coupled to the at least one processor. The at least one processor is configured to cause the vehicle to: obtain IVN configuration information corresponding to a particular IVN system configuration for the vehicle; configure one or more sensors of the plurality of sensors, one or more ECUs of the plurality of ECUs, or both, for unicast and groupcast wireless communications based on the IVN configuration information; and wirelessly transmit via the one or more sensors or the one or more ECUs using the particular IVN system configuration.

In one aspect of the disclosure, a method of wireless communication at a vehicle including a plurality of sensors, a plurality of electronic control units (ECUs), wherein the plurality of sensors and the plurality of ECUs correspond to a plurality of in-vehicle networks (IVNs) of an IVN system, is disclosed. The method includes: obtaining IVN configuration information corresponding to a particular IVN system configuration for the vehicle; configuring one or more sensors of the plurality of sensors, one or more ECUs of the plurality of ECUs, or both, for unicast and groupcast wireless communications based on the IVN configuration information; and wirelessly transmitting via the one or more sensors or the one or more ECUs using the particular IVN system configuration.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a network node and a user equipment (UE) according to one or more aspects.

FIG. 3 is a block diagram illustrating an example of an in-vehicle network (IVN) system with wired devices according to one or more aspects.

FIG. 4 is a block diagram illustrating an example of an IVN system with wireless devices according to one or more aspects.

FIGS. 5A and 5B are each a block diagram illustrating an example of online or offline configuration of wireless devices according to one or more aspects.

FIG. 6 is a block diagram illustrating an example vehicle that supports enhanced IVN configuration operations according to one or more aspects.

FIG. 7 is a block diagram illustrating an example vehicle that supports enhanced IVN configuration operations according to one or more aspects.

FIG. 8 is a flow diagram illustrating an example process that supports enhanced IVN configuration operations according to one or more aspects.

FIG. 9 is a block diagram of an example vehicle that supports enhanced IVN configuration operations according to one or more aspects.

FIG. 10 is a block diagram of an example wireless communication device that supports enhanced IVN configuration operations according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Vehicles are being designed to include advanced wireless communication systems and may correspond to user devices that interact with wireless networks and directly with other user devices (e.g., other vehicles and transportation infrastructure). For example, vehicles may include one or more wireless communication systems, such as cellular communication system, Wi-Fi and Bluetooth communication systems, and Vehicle-to-everything (V2X) communication systems to communicate with directly with other vehicles or via base stations. Additionally, research and development is being performed into converting in-vehicle wired networks to in-vehicle wireless or hybrid networks including both wireless and wired devices. However, in-vehicle wired networks are complex, using multiple, disparate standards and physical wire types, such as Controller Area Network (CAN), FlexRay, Local Interconnect Network (LIN), Media Oriented Systems Transport (MOST), Ethernet, low-voltage differential signaling (LVDS), etc., for communication to a large number of vehicle sensors and ECUs.

Designing, managing and maintaining a wireless or hybrid IVN communication system that can replace the wired networks and that can enable wireless communications throughout the vehicle and to devices outside the vehicle is a complex and costly process. In addition to the design challenges in crafting a wireless system to replace the wired networks, wireless devices have their own operational challenges and can suffer from interference when operating in vehicles. For example, the components of the vehicles, such as a gasoline powered engine or electrical motor may generate a lot of RF interference that can disrupt wireless communications, and when so many small wireless devices are transmitting in a confined space, intra-vehicle communication interference can be challenging. Moreover, component degradation and updates may affect the wireless networks as the vehicle goes through its lifecycle. Thus, any in-vehicle wireless networks may require adjustment and reconfiguration during the life of the vehicle.

In an effort to simplify the design of wireless networks of current and future vehicles and replacement of wired networks, the aspects herein propose to design wireless networks of the IVN system around existing wired communication buses or groups of the current IVN systems. For example, to create a first wireless group corresponding to a first wired bus, and to create a second wireless group corresponding to a second wired bus. In an effort to simplify the configuration, management, and operations of the complex wireless or hybrid networks of current and future vehicles, the aspects herein also propose to use groupcast and unicast configuration techniques to enable configuration and operation of the wireless groups and/or networks of vehicles. For example, the different wireless groups or networks (that may correspond to original wired communication networks/buses), may be configured into a wireless group for groupcast communication and groupcast configuration. Additionally, each sensor is also configured for unicast transmission with a unicast configuration that may be configured or reconfigured via unicast or groupcast transmission. In some aspects, the aspect described herein may leverage Service Enabler Architecture Layer (SEAL) and/or Vertical Application Layer (VAL) techniques to configure wireless devices of wireless networks or may use Personal IoT network Application (PINAPP) techniques to configure wireless devices of wireless networks.

Various aspects describe herein relate generally to vehicle IVNs and more particularly to designing wireless or hybrid IVN systems and configuring wireless devices of the enhanced or hybrid IVNs for enabling unicast and groupcast transmissions for the wireless devices. Some aspects more specifically relate to configuring devices of IVNs with IVN configuration information to manage unicast and groupcast transmissions within the vehicle and to external devices outside of the vehicle. In some examples, the IVN configuration information includes User ID information, UE information, and Group ID information to enable dynamic configuration (and reconfiguration) of wireless devices for unicast and groupcast transmissions. The IVN configuration information may be used as or to identify UEs associated with each device.

In some examples, the vehicle or a component thereof, such as a master ECU, may generate the IVN configuration information to enable the vehicle to engage in IVN system configuration or management offline and when not connected to a network. The internal or offline generation of IVN configuration information enables the vehicle to account for changes in performance or improve/optimize internal wireless transmission performance when not connected to a network or remote manager.

In some examples, real-time performance data from actual vehicle operation over the life of the vehicle is used by the vehicle or sent to a server for dynamic reconfiguration of the IVN systems. The use of real-time performance data enables the vehicle or a remote manager to more accurately tune the wireless operations of the vehicle in specific operating scenarios and conditions, and to account for vehicle changes or degradation in performance over the life of the vehicle, including changes due to modifications, component failure, and wear and tear on the vehicle.

Particular aspects of the subject matter described in the disclosure can be implemented to realize one or more of the following advantages. In some examples, by utilizing the IVN configuration information described herein, flexible unicast and groupcast links within the vehicle and to remote devices can be established and dynamically managed by the remote server or vehicle. The usage of the disclosed IVN configuration information and the different techniques for obtaining it enables the vehicle to be more efficiently designed and managed over the life of the vehicle no matter if the vehicle is online or offline, such as connected to a remote server or not. Such flexible and dynamic configuration and reconfiguration of the wireless devices of the IVN system of the vehicle can create new unicast and/or groupcast links to reduce interference, compensate for a component failure, add new functionality, participate in network provided services, and respond to transient conditions or changes.

In some examples, by utilizing real-time performance data capture and modification of the IVN configuration based on the real-time performance data enables the vehicle or remote server to account for component degradation and failure and to account for transient conditions when reconfiguring the wireless operations of the IVN system. The creation and use of real-time performance data from actual vehicle operation over the life of the vehicle solves some of the current challenges and issues with maintaining accurate and high performing wireless IVN systems for vehicles which may operate in different environments and to account for system changes to the vehicle over time.

In some examples, engaging in vehicle-side or vehicle-generated IVN configuration or reconfiguration enables the vehicle to generate IVN configuration information and manage the IVN system even when offline. The IVN configuration or reconfiguration can be based on real-time performance data from the actual vehicle and can be used to automatically update the wireless devices of the IVN system and vehicle's operations over the life of the vehicle to account for changes in the vehicle and environment. The vehicle-side or vehicle-generated IVN configuration information may be more accurate than using data or configurations from other vehicles, such as test vehicles or vehicles that experience different conditions, as the data accounts for the specific configuration and condition of the vehicle and of its operating environment(s).

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

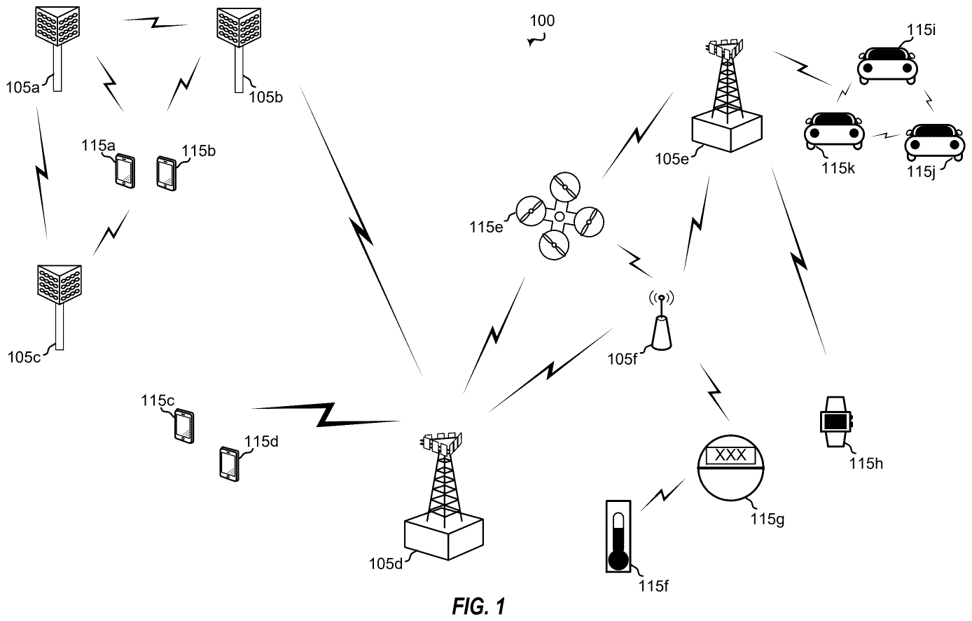

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of network nodes 105 and other network entities. A network node (e.g., base station) may communicate with the UEs and may also be referred to as an evolved node B (eNB), a next generation eNB (gNB), an access point, and the like. Each network node 105 may provide communication coverage for a particular geographic area. In 3GPP, the term “cell” may refer to this particular geographic coverage area of a network node (e.g., a base station or a base station subsystem) serving the coverage area, depending on the context in which the term is used. In implementations of wireless network 100 herein, network nodes 105 may be associated with a same operator or different operators (e.g., wireless network 100 may include a plurality of operator wireless networks). Additionally, in implementations of wireless network 100 herein, network node 105 may provide wireless communications using one or more of the same frequencies (e.g., one or more frequency bands in licensed spectrum, unlicensed spectrum, or a combination thereof) as a neighboring cell. In some examples, an individual network node 105 or UE 115 may be operated by more than one network operating entity. In some other examples, each network node 105 and UE 115 may be operated by a single network operating entity.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc. ; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100. The UEs may include one or more V2X infrastructure devices, such as UEs associated with vehicles and vehicle infrastructure. The UEs associated with vehicles may include vehicle UEs (e.g., a UE integrated with an automobile) and UEs located inside of a vehicle.

A mobile apparatus, such as UEs 115, may be able to communicate with any type of the network nodes, whether V2X infrastructure (e.g., roadside unit (RSU), vulnerable road user (VRU) device, traffic light), macro base stations, pico base stations, femto base stations, relays, and the like. In FIG. 1, a communication link (represented as a lightning bolt) indicates wireless transmissions between a UE and a serving network node, which may be a base station designated to serve the UE on the downlink or uplink, or desired transmission between base stations, and backhaul transmissions between base stations. UEs may operate as base stations or other network nodes in some scenarios. Backhaul communication between network nodes of wireless network 100 may occur using wired or wireless communication links.

In operation at wireless network 100, network nodes 105a-105c serve UEs 115a and 115b using 3D beamforming and coordinated spatial techniques, such as coordinated multipoint (CoMP) or multi-connectivity. Macro base station 105d performs backhaul communications with network nodes 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 supports mission critical communications with ultra-reliable and redundant links for mission critical devices, such as UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

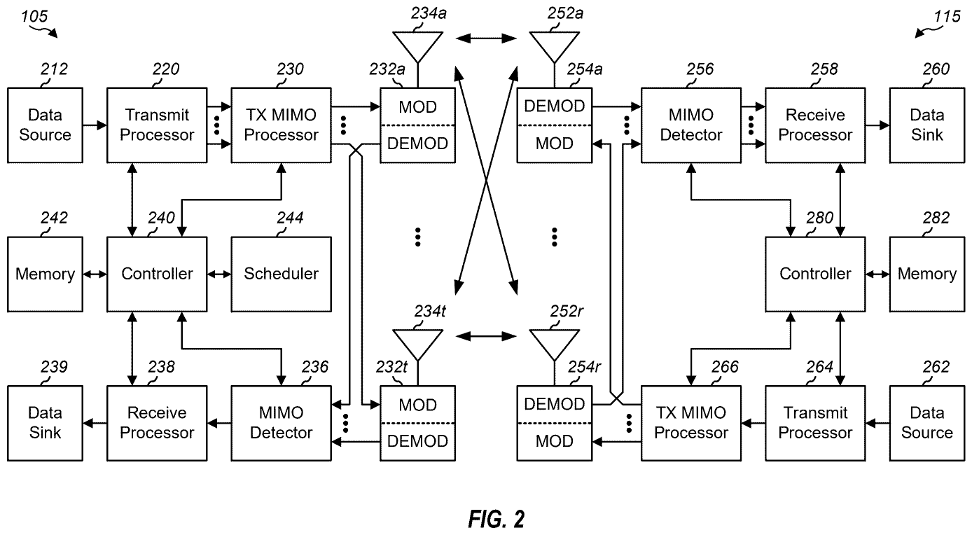

FIG. 2 is a block diagram illustrating examples of network node 105 and UE 115 according to one or more aspects. Network node 105 and UE 115 may be any of the base stations and one of the UEs in FIG. 1. For a restricted association scenario (as mentioned above), network node 105 may be small cell base station 105f in FIG. 1, and UE 115 may be UE 115c or 115d operating in a service area of base station 105f, which in order to access small cell base station 105f, would be included in a list of accessible UEs for small cell base station 105f. Network node 105 may also be a base station of some other type. As shown in FIG. 2, network node 105 may be equipped with antennas 234a through 234t, and UE 115 may be equipped with antennas 252a through 252r for facilitating wireless communications.

At network node 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from network node 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to network node 105. At network node 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

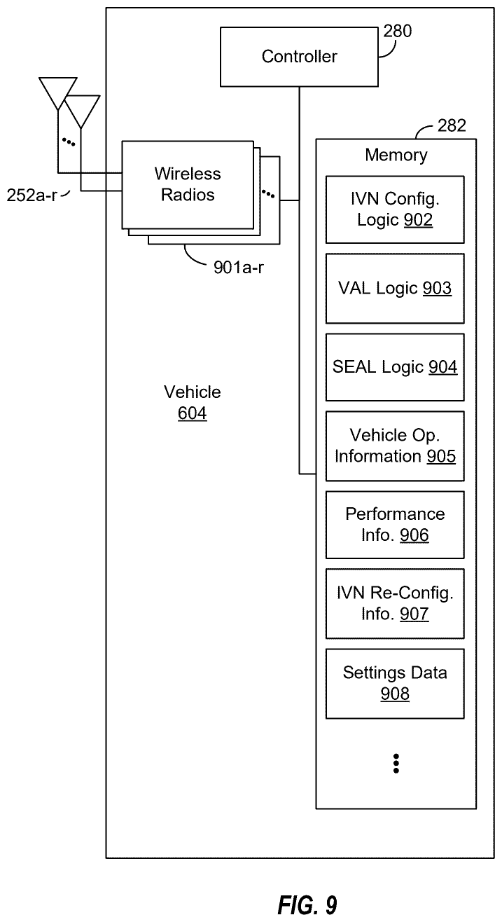

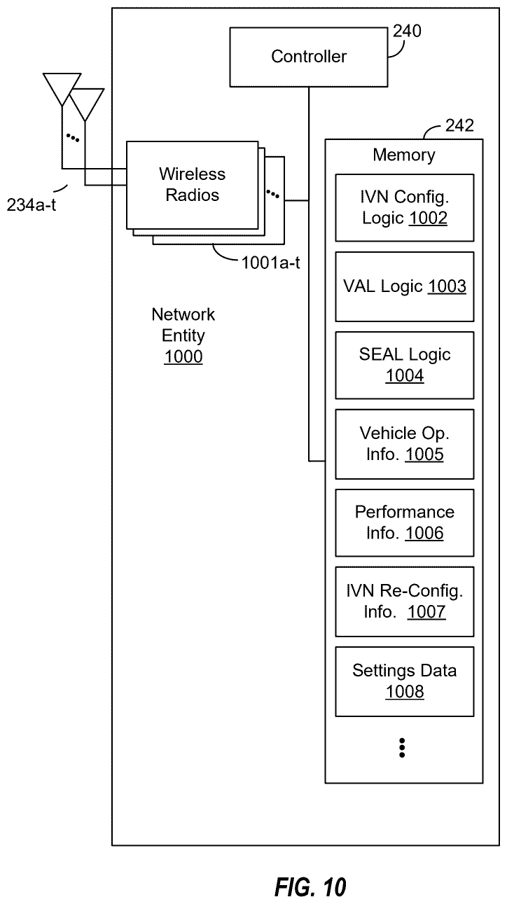

Controllers 240 and 280 may direct the operation at network node 105 and UE 115, respectively. Controller 240 or other processors and modules at network node 105 or controller 280 or other processors and modules at UE 115 may perform or direct the execution of various processes for the techniques described herein, such as to perform or direct the execution illustrated in FIGS. 9 and 10, or other processes for the techniques described herein. Memories 242 and 282 may store data and program codes for network node 105 and UE 115, respectively. Scheduler 244 may schedule UEs for data transmission on the downlink or the uplink.

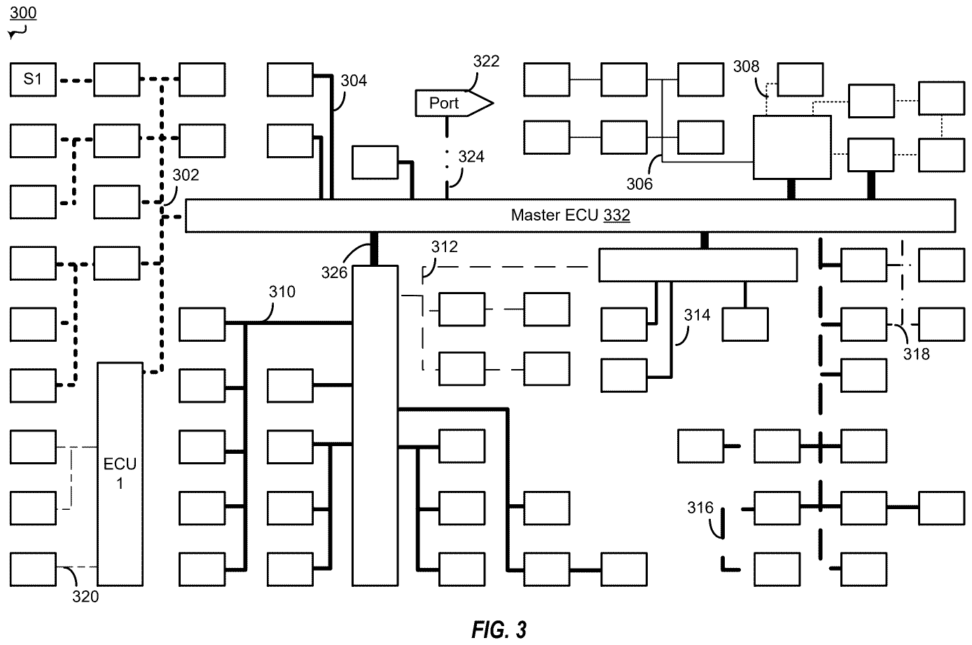

FIG. 3 illustrates a diagram 300 depicting a representative example of an In-Vehicle Wired Network System. In-Vehicle Wired Network Systems may include multiple in-vehicle networks (IVNs) of different technologies (e.g., CAN, LIN, FlexRay, LVDS, etc.) and multiple IVNs of the same technology (e.g., multiple CAN and multiple LIN bus networks). Each IVN may include multiple devices of different types, such as one or more sensors, one or more ECUs, etc. In some aspects, the sensors may be coupled to an ECU to form a sensor group, and the ECUs may be coupled together or may talk to each other across groups, often referred to as a gateway ECU, to enable communication across the different types of wired networks. Thus, the In-Vehicle Wired Network System can support communications across the entire vehicle, that is across the different IVNs thereof, to enable operations of the vehicle.

The representative example illustrated in the diagram 300 includes multiple wired networks, IVNs 302-320. For example, the IVN system includes a first wired network, first IVN 302, a second wired network, second IVN 304, a third wired network, third IVN 306, etc., a ninth wired network, ninth IVN 318, and a tenth wired network, tenth IVN 320. One or more of the IVNs may be connected to each other. In the example of FIG. 3, each of the IVNs 302-320 is connected to each other (e.g., communicatively coupled) via a master ECU 332. The master ECU 332 may be coupled directly (as in the example of FIG. 3) or indirectly to each of the IVNs 302-318, such as by connections 326. Each IVN may include one or more sensors and one or more ECUs. For example, the first IVN 302 includes a first sensor (S1) and a first ECU (ECU1). In the example of FIG. 3, the first ECU (ECU1) is a gateway ECU as it capable of communicating on two different wired networks, the first IVN 302 and the tenth IVN 320.

The vehicle may also include a port, such as an OBD port, to connect to external devices, such as for diagnostics and programming of the IVNs 302-320 of the IVN system. In the example of FIG. 3, the IVN includes a port 322 that can be coupled to an external device for OBD operations,

However, as mentioned above, wired IVNs are costly, complex, and add significant weight to the vehicle. This added weight reduces overall performance of the vehicle and increases vehicle component and operational costs. In addition, fixed wired networks are static and have fixed wired paths and data links. These paths are often not changeable to account for changes to the vehicle, such as due to performance degradation (e.g., wear and tear), vehicle modifications, component failure, etc.

In the aspects described herein, groupcast and unicast network topology and techniques are applied to vehicle in-vehicle networks (IVNs) to enable various improvements to vehicle design, vehicle configuration, and real-time vehicle operation/reconfiguration. IVNs of a vehicle include many components, such as sensors and ECUs. In the described aspects, these sensors and ECUs are configured with unicast and groupcast configurations to enable flexible and reconfigurable wireless communications between the IVNs components and the IVNs themselves. For example, the localized nature of vehicle wired networks, and the multiple, overlapping wired networks between different sensor/ECU groups can be mapped to sidelink communication techniques, specifically to managed Groupcast and Unicast transmissions. Support for multiple, simultaneous Unicast and Groupcast links enables sensors and ECUs to communicate across multiple wireless equivalents of wired networks, and allows Gateway ECUs (e.g., ECUs bridging in-vehicle wired networks of the same or different technologies) to communicate with each other.

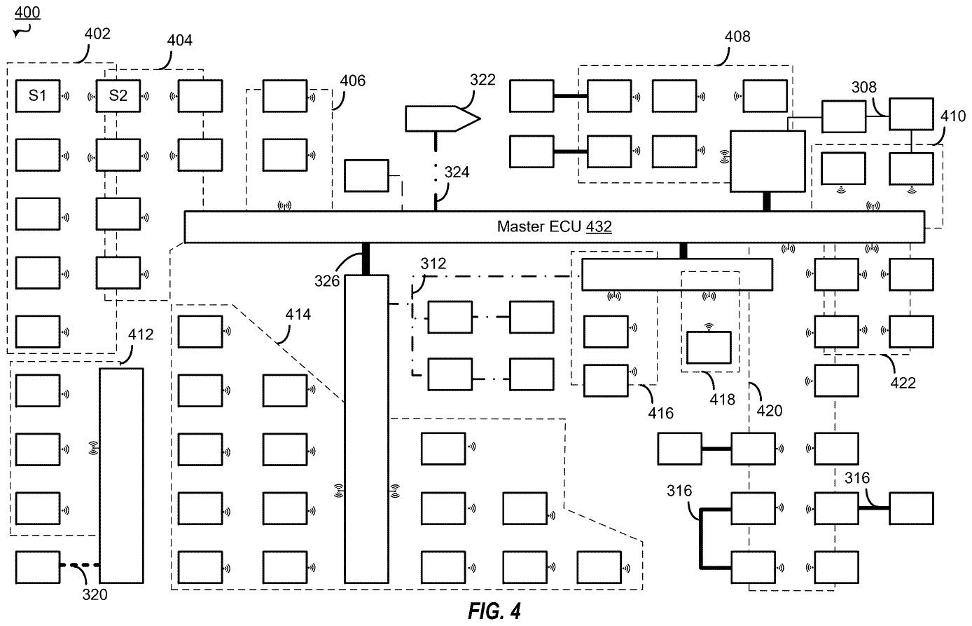

The IVN configurations described herein may be generated based on local and/or remote criteria. For example, local interference metrics, IVN component load, IVN component status, IVN performance, device mode, device updates, vehicle report information, etc. One such example is provided with reference to diagram 400 of FIG. 4 and corresponds to a modified IVN system of the one illustrated in the diagram 300 of FIG. 3 with wireless communications replacing some of the wired IVNs. This example IVN configuration may be generated based on replacing wired IVN networks of an existing IVN system with corresponding wireless groupcast groups. Such may be done by an auto OEM upon construction and/or original configuration to convert an existing wired IVN system to a wireless or hybrid IVN system with managed groups for simultaneous unicast and groupcast transmissions. Additionally, or alternatively, the example IVN configuration may be received wirelessly from an external devices or generated by the vehicle itself, and then dynamically updated over time by a remote device or the vehicle to enable flexible wireless communications as described further herein.

FIG. 4 illustrates a diagram 400 depicting a representative example of an enhanced In-Vehicle Network with configurable wireless networks. In the aspects described herein, the enhanced IVNs may include one or more of the wired networks (e.g., at least a portion thereof) as described with reference to FIG. 3, and further include multiple wireless networks of different wireless technologies/protocols (e.g., cellular, Wi-Fi, Bluetooth, Z-wave, Zigbee, etc.) and/or the same technology/protocol (e.g., multiple Wi-Fi and multiple Bluetooth networks). In the example of FIG. 4, the IVN system is a hybrid IVN system with multiple wired and wireless networks.

Similar to the wired networks of FIG. 3, each wireless network (or wireless group) may include multiple devices of different types, such as one or more sensors, one or more ECUs, etc. In some aspects, the sensors may be coupled to an ECU to form a sensor group, and the ECUs may be coupled together or may talk to each other across groups, often referred to as a gateway ECU, to enable communication across the different types of wired networks. Additionally, wired and wireless devices can be part of a same wireless group and managed together as a group. Thus, the enhanced IVNs can support flexible wireless unicast and groupcast communications to and from the vehicle and across the entire vehicle and configuration or reconfiguration of the wireless networks.

The representative example illustrated in the diagram 400 includes multiple wired networks, IVNs 308, 312, 316, and 320, and multiple wireless networks, wireless IVNs 402-422. For example, the IVN system includes portions of the wired networks, IVNs 308, 312, 316, and 320, of FIG. 3, and a first wireless network, first wireless IVN 402, a second wireless network, second wireless IVN 404, a third wireless network, third wireless IVN 406, etc., a tenth wireless network, tenth wireless IVN 420, and an eleventh wireless network, eleventh wireless IVN 422. One or more of the IVNs may be connected to each other. In the example of FIG. 4, each of the IVNs 308, 312, 316, and 320 and of the wireless IVNs 402-422 are connected to each other (e.g., communicatively coupled) via a master ECU 432. The master ECU 432 may be coupled directly (as in the example of FIG. 3) or indirectly to each of the wired and wireless IVNs, such as by wired connections 326 or wireless connections of different wireless communication groups.

As illustrated in the example of FIG. 4, each wireless IVN has a corresponding wireless communication group corresponding to one or more sensors and one or more ECUs. The devices of a particular wireless group may be part of one or more additional groups. For example, the first wireless IVN 402 includes multiple sensors and ECUs, including a first sensor (S1) and including a second sensor (S2), that is also a part of the second wireless IVN 404 and is configured to communicate in both of the wireless IVNs. The first and second wireless IVNs 402 and 404 may have a same wireless communication type or protocol or a different wireless communication type. In the example of FIG. 4, the second sensor (S2) may be coupled directly to the master ECU 432 via the second wireless IVN 404 but not the first wireless IVN 402. The second sensor (S2) may be configured to transmit communications (e.g., application data or configuration information) within each of its wireless IVNs and may be configured to relay information from the master ECU 432 received via the second wireless IVN 404 to other devices of the first wireless IVN 402, and/or may be configured to relay information from the other devices of the first wireless IVN 402 to the master ECU 432 via the second wireless IVN 404. The vehicle may also include a port, such as port 322, to connect to external devices, such as for diagnostics and programming of the wired and/or wireless IVNs of the hybrid IVN system of FIG. 4.

In order to implement and manage wireless communications between such wireless devices and groups of different IVN wireless networks of an IVN system, IVN configuration information is obtained by the vehicle (e.g., received or generated). To illustrate, the IVN configuration information may be provided by a configuration system or device to the vehicle and distributed to the IVN components thereof to setup and manage the devices of the IVNs. The IVN configuration information enables the setup of a particular IVN system configuration (e.g., the unicast and groupcast links or network topology of the vehicle), and changing from a current IVN system configuration to a desired or target IVN system configuration.

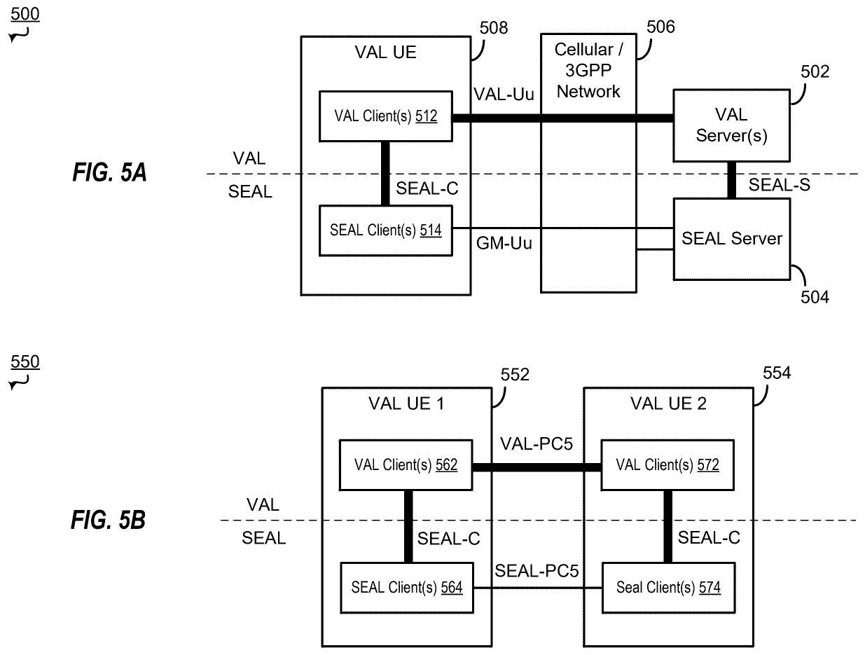

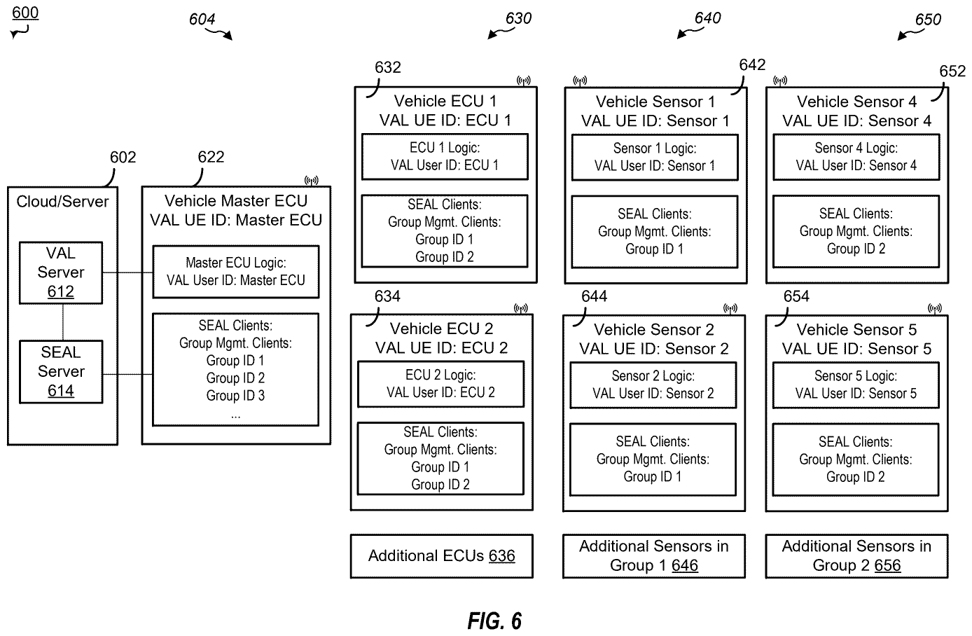

As one example, a 3GPP SEAL (Service Enable Architecture Layer for Verticals) architecture can be used to manage the IVN components, e.g., the individual Sensors and/or ECUs and the groups of Sensors and ECUs. The management of the devices (sensors and/or ECUs) of the IVNs can be performed remotely by an auto OEM or a third-party via cellular communications (e.g., Uu) or by an infrastructure-less connection (e.g., PC5), locally by an external device (e.g., plugged into a port on the vehicle or via a local wireless connection), or by the vehicle itself (e.g., in an offline mode by a master controller or ECU). For example, device management for unicast and/or groupcast configuration can be via SEAL messages (e.g., using SEAL application programming interfaces (APIs)) to the individual devices themselves, to a master ECU for individual groups of devices, or to a vehicle master ECU or ECU for local distribution to the individual devices or groups. Examples of such configuration are further described with reference to FIGS. 5A, 5B, and 6.

FIGS. 5A and 5B illustrate exemplary diagrams 500 and 550 that depict an example of an online service configuration and an offline service configuration respectively for wireless devices. Specifically, FIGS. 5A and 5B describe VAL and SEAL based configuration of wireless devices, such as for service-focused or service-based wireless communication networks. The online and offline configurations may be used for or applied to designing, configuring, and managing IVN wireless and hybrid networks.

In the online (or on-network) mode, an IVN manager (e.g., a SEAL server) provides IVN configuration information wirelessly to the vehicle via a cellular or 3GPP network or via a device-to-device link (e.g., sidelink) from an infrastructure-based RSU as illustrative non-limiting examples. Once the IVN configuration is received by the vehicle, the IVN configuration is applied to the indicated IVN components and then the IVN components of the vehicle can exchange unicast and/or groupcast communications wirelessly using the received IVN configuration. Additionally, or alternatively, the IVN components of the vehicle can exchange communications with the VAL server, such as to engage in the services provided by the network and/or remote devices.

Referring to FIG. 5A, the online service configuration of diagram 500 includes one or more VAL servers 502, a SEAL server 504, a cellular network 506, and a VAL UE 508. The one or more VAL servers 502 are each configured to provide server side functionalities corresponding to one or more vertical applications (e.g. V2X application servers, OEM IVN configuration servers, OTA update configuration servers, etc.). The one or more VAL servers 502 may be configured to support and utilize API connections (e.g., act as an API invoker). The one or more VAL servers 502 are coupled to the SEAL server 504. For example, each of the one or more VAL servers 502 is coupled to the SEAL server 504 via a SEAL-S connection. The one or more VAL servers 502 are also coupled to the cellular network 506. For example, each of the one or more VAL servers 502 is coupled to the cellular network 506 via a network connection (e.g., ethernet/the Internet) or a Uu connection.

The SEAL server 504 is configured to provide server side functionalities corresponding to one or more specific SEAL services. The SEAL server 504 is configured to support interactions with one or more the VAL server(s) 502. The SEAL server 504 is configured to support API determination and usage (e.g., an API exposing function). The SEAL server 504 is also configured to support interactions with one or more other SEAL servers in a distributed SEAL deployment configuration. The SEAL server 504 is also coupled to the cellular network 506. For example, the SEAL server 504 is coupled to the cellular network 506 via a network connection (e.g., ethernet/the Internet) or a Uu connection.

The cellular network 506 may include or correspond to one or more components of the wireless network 100 of FIG. 1, such as a core network and one or more base stations. The cellular network 506 is further coupled to the VAL UE 508. For example, the cellular network 506 provides a connection from the one or more VAL servers 502 to the one or more VAL clients 512 of the VAL UE 508 and provides a connection from the SEAL server 504 to the one or more SEAL clients 514 of the VAL UE 508. To illustrate, the cellular network 506 provides a VAL-Uu connection from the one or more VAL servers 502 to the one or more VAL clients 512 of the VAL UE 508, and the cellular network 506 provides a SEAL-Uu or GM-Uu connection from the SEAL server 504 to the one or more SEAL clients 514 of the VAL UE 508.

The VAL UE 508 may include or correspond to a user device, such as the vehicle itself or one or more components of an IVN of the vehicle, such as a master ECU or TCU. The VAL UE 508 includes one or more VAL clients 512 and one or more SEAL clients 514. Each of the one or more VAL clients 512 is configured to provides client side functionalities corresponding to the vertical applications (e.g. V2X client). The VAL clients are configured to support interactions with the one or more SEAL client(s) 514.

Each of the one or more SEAL clients 514 is configured to provide client side functionalities corresponding to the specific SEAL service. The SEAL client(s) 514 are configured to support interactions with the VAL client(s). The SEAL client(s) 514 are also configured to supports interactions with the corresponding SEAL client between the two UEs. The one or more VAL clients 512 and the one or more SEAL clients 514 are also coupled together. For example, each of the one or more VAL clients 512 is coupled to at least one of the one or more SEAL clients 514 via a SEAL-C connection.

One or more SEAL services (e.g., functional entities) may be supported by the VAL itself or towards the VAL UE 508, such as Location management, Group management, Configuration management, Identity management, Key management, Network resource management, Data delivery, or any combination thereof. The SEAL clients and server may provide the SEAL services, such as user and group management.

During operation, in the vertical application layer, a VAL client of the VAL clients 512 communicates with the VAL server 502 over the VAL-Uu link, which supports both unicast and multicast delivery modes. The SEAL functional entities on the VAL UE 508 and the SEAL server 504 are grouped into SEAL client(s) 514 and SEAL server(s) respectively. The SEAL consists of a common set of services (e.g. group management, location management) and links. The SEAL offers its services to the VAL.

The SEAL client(s) 514 communicates with the SEAL server(s) 504 over the SEAL-Uu link, which also supports both unicast and multicast delivery modes. The SEAL client(s) 514 provide the service enabler layer support functions to the VAL client(s) over SEAL-C link. The VAL server(s) 502 communicates with the SEAL server(s) 504 over the SEAL-S link, and the SEAL server(s) 504 may communicate with the underlying 3GPP network systems of the cellular network 506 using the respective 3GPP interfaces specified by the 3GPP network system. The specific SEAL client(s) 514 and the SEAL server(s) 504 along with their specific SEAL-Uu links are described in the respective on-network functional model for each SEAL service further herein.

In some aspects, such as to support distributed SEAL server deployments, a first SEAL server interacts with a second SEAL server for the same SEAL service over a SEAL-E link. The SEAL servers may also communication with a VAL server, or a VAL user database associated therewith over the SEAL-S link or a separate link (e.g., User database link) for storing and retrieving user profiles.

In the offline (or off-network) mode, the vehicle may receive the IVN configuration via a local external device, such as via a wired port (e.g., OBD2 port), via a sidelink cellular connection (e.g., PC5) or via a local wireless protocol (e.g., Wi-Fi, Bluetooth, Z-wave, Zigbee, etc.). Alternatively, one component of the vehicle (e.g., a master ECU, TCU, controller, etc.) may determine a reconfiguration of the IVN system. For example, the vehicle component may determine a reconfiguration based on the original configuration and operational performance data, network update data, or a combination thereof. To illustrate, when the vehicle is in an offline mode and not connected to a SEAL server, the vehicle may adjust its IVN configuration based on an increase in interference experienced by one or more components or based on a sensor or ECU malfunction or failure. The vehicle or a component thereof may act as a VAL and/or SEAL server to support the wireless communication configuration operations and transmission and/or reception operations.

Referring to FIG. 5B, the offline service configuration of diagram 550 includes two or more UEs, such as a first VAL UE 552 and a second VAL UE 554. Each of the first VAL UE 552 and the second VAL UE 554 includes one or more VAL and SEAL clients similar to the VAL UE 508 of FIG. 5A. As illustrated in the example of FIG. 5B, the first VAL UE 552 includes one or more VAL clients 562 and one or more SEAL clients 564, and the second VAL UE 554 includes one or more VAL clients 572 and one or more SEAL clients 574. The VAL and SEAL clients of a particular UE are coupled via an intra-device SEAL link, such a SEAL-C data link, and the VAL and SEAL clients of each device are coupled to the corresponding VAL and SEAL clients of another devices via a sidelink or D2D link, such as a VAL-PC5 link and a SEAL-PC5 data link respectively.

In some aspects, one of the UEs may include or correspond to a master device or configuration device and include configuration and logic similar to the VAL and SEAL servers of FIG. 5A and is able to configure one or more other UEs. For example, the first VAL UE 552 can configure or provide services to the second VAL UE 554, when the one or more of the VAL UEs are not connected to the cellular network 506 (or VAL and SEAL servers) as in FIG. 5A.

During operation, in the vertical application layer, a VAL client of the one or more VAL clients 562 of first VAL UE 552 communicates with a VAL client of the one or more VAL clients 572 of the second VAL UE 554 over the VAL-PC5 link to provide or engage in services. Entities within the application plane of a VAL system provide application control and media specific functions to support one or more VAL services.

A SEAL client of the first VAL UE 552 interacts with the corresponding SEAL client of the second VAL UE 554 over the SEAL-PC5 links to provide or engage in services or to provide or engage in communication/group management. In some aspects, if the first VAL UE 552 is connected to the cellular network 506 of FIG. 5A via the Uu link, the first VAL UE 552 can also act as a UE-to-network relay, to enable the second VAL UE 554 to access the VAL server(s) over the VAL-Uu link. The specific SEAL client(s) along with their specific SEAL-PC5 links are described in the respective off-network functional model for each SEAL service further herein.

While multicast transmissions have been proposed to be supported for VAL and SEAL architectures, multicast transmissions are currently not supported under VAL and SEAL architectures. In the aspects herein, groupcast and unicast configurations and communications techniques are disclosed. For example, techniques for extending managed unicast and groupcast wireless communications to vehicle IVNs are disclosed.

When extending managed unicast and groupcast wireless communications to vehicle IVN systems, aspects of VAL and/or SEAL servers may be leveraged to enable flexible and dynamic configuration and reconfiguration of devices of IVN systems. For example, a first server (e.g., a management or SEAL server) can provide management features which a second server (e.g., application or VAL server) can utilize for IVN management. The first server (e.g., a management or SEAL server) can provide group management operations, such as Group creation/deletion, membership update, join, leave, group configuration, etc., and can provide configuration management operations, such as profile retrieval, service configuration retrieval, etc. The second server may instruct or coordinate the operations of the first server to setup or reconfigure the IVN and then may communicate with the IVN (e.g., devices thereof) to provide services and receive data (e.g., application data, sensor data, etc.). In the aspects described herein, Each Sensor/ECU is considered an individual unit assigned a user identifier (e.g., VAL User ID), and each Sensor/ECU control and logic is mapped to an application client (e.g., a Vertical Application Client (VAL Client) and one or more individual SEAL client(s)). Each Sensor/ECU is also assigned (or a UE associated therewith) a UE identifier, (e.g., a VAL UE ID) for performing wireless transmission and reception operations.

Wireless groups (e.g., groups of Sensors and/or ECUs) are also assigned a group identifier (e.g., a VAL group ID or VAL service ID). For example, a group of Sensors and their associated ECU(s) on the Powertrain CAN with wireless capability (e.g., each with their own user identifier) can be assigned a group identifier. Individual Sensors/ECUs may have more than one group identifier (e.g., a Gateway ECU communicating across multiple buses/or groups).

A remote entity (e.g., an auto OEM) can manage the devices of the IVN and provide related services, by acting as a Vertical Application Server or servers. The remote entity may utilize SEAL (e.g., SEAL APIs) to provide group/configuration management related instructions to a SEAL server controlled by them or another party to place devices of the IVN system into groups and/or reconfigure the devices for specific services. For example, the VAL server(s) communicate with the SEAL servers to provide the configurations or updates, and the SEAL server(s) generate instructions that are provided to SEAL clients for configuring the device of the IVN.

FIG. 6 illustrates a diagram 600 illustrating an example of a system for enhanced configuration operations for a IVN system with wireless groups. In diagram 600, the system includes cloud or server infrastructure 602 and a vehicle 604 including an enhanced wireless or hybrid IVN system. The system illustrated in FIG. 6 illustrates one example of extending VAL and SEAL architecture to wireless or hybrid IVN systems to enable groupcast and unicast configuration and communications.

In the example of FIG. 6, the cloud or server infrastructure 602 includes a VAL server 612 and a SEAL server 614. Although one VAL server and one SEAL server are illustrated for simplicity, in other examples the cloud or server infrastructure 602 includes multiple VAL and/or SEAL servers. Additionally, although the one VAL server and one SEAL server are shown in a single box for the cloud or server infrastructure 602, the VAL and SEAL servers may be separate from another, that is not co-located in the same place or part of a single device or entity. The VAL server 612, the SEAL server 614, or both may have a distributed architecture. The VAL server 612 may include or correspond to a VAL server as described with reference to FIGS. 5A and/or 5B. The SEAL server 614 may include or correspond to a SEAL server as described with reference to FIGS. 5A and/or 5B. Although VAL and SEAL servers are illustrated in the example of FIG. 6, the servers may be other types of servers with similar functionality, such as application data services functionality and wireless communication management functionality.

In the example of FIG. 6, the vehicle 604 includes a master ECU 622, a plurality of ECUs 630, a first plurality of sensors 640, and a second plurality of sensors 650. The plurality of ECUs 630 includes a first ECU 632, a second ECU 634, and optionally one or more additional ECUs 636. The first plurality of sensors 640 includes a first sensor 642, a second sensor 644, and optionally one or more additional first group sensors 646 (e.g., Sensor 3). The second plurality of sensors 650 includes a third sensor 652, a fourth sensor 654, and optionally one or more additional second group sensors 656.

Each of the ECUs and sensors of the vehicle 604 may include or correspond to an ECU or a sensor as described with reference to FIGS. 5A and/or 5B. For example, each of the ECUs and sensors may include one or more VAL clients and one or more SEAL clients. The VAL clients may include or correspond to a VAL client as described with reference to FIGS. 5A and/or 5B, and the SEAL clients may include or correspond to a SEAL client as described with reference to FIGS. 5A and/or 5B.

As compared to the wired data links between the different devices in the example of FIG. 3, in the example of FIG. 6, the ECUs and sensors are configured for wireless communications and may be configured to communicate with one another via unicast and groupcast transmissions. The particular wireless communication configurations, that is the specific data links and wireless connections between the devices of the vehicle 604 may be configurable.

The configuration/reconfiguration of the wireless devices and unicast and groupcast transmission capabilities may be enabled by IVN configuration information. The IVN configuration information may include a unique device identifier, a configurable unicast identifier, and one or more configurable groupcast identifiers to configure the ECUs and sensors for wireless communications. Specifically, in the example of FIG. 6, the IVN configuration information includes a VAL UE ID, a VAL User ID, and one or more VAL Group IDs for each ECU and sensor of the vehicle 604. These specific pieces of information or information elements may enable a dynamic and configurable wireless communication system with multiple wireless groups that can be configured as single devices (e.g., via unicast communications) or as a group (e.g., via groupcast communications, and may enable unicast and groupcast transmissions throughout the vehicle 604 and even to devices outside the vehicle 604, such as other vehicles, RSUs, external VAL and SEAL servers, etc. For example, a VAL user ID may be assigned to each individual device, such as sensor or ECU of the IVN system and identify each device. The VAL UE ID may be associated with the VAL User ID and/or a specific device and provide an ID of the UE providing the device with wireless communication capabilities (e.g., unicast wireless communications). The VAL Group IDs may be associated with the specific device, such as by association with the VAL User ID and/or VAL UE ID and provide an ID or IDs of groups associated with the specific device and providing the device with wireless communication capabilities (e.g., groupcast wireless communications). The VAL user, UE and Group IDs may also provide the specific devices with wireless configuration capabilities, such as single and group configuration / reconfiguration capabilities. Although not shown for clarity, the VAL and SEAL clients of the ECUs and sensors may include wired or wireless data links between each other as described with reference to FIGS. 5A and 5B.

In the example of FIG. 6, the IVN configuration of the vehicle 604 is such that the master ECU 622 coordinates IVN configuration operations for the vehicle 604. The master ECU 622 is a gateway ECU that can talk to multiple wireless groups and devices of different protocols and that can also be used to distribute IVN configuration information received from the cloud or server infrastructure 602. In some aspects, the master ECU 622 can additionally generate or adjust the IVN configuration information to dynamically reconfigure the wireless settings and unicast and groupcast links of the IVN networks, such as by adjusting one or more of the VAL UE ID, the VAL User ID, or the one or more VAL Group IDs.

In the IVN configuration information, the master ECU 622 is configured with VAL Group IDs for all Groups, such as Group ID 1, Group ID 2, Group ID 3, etc. A first group corresponding to the Group ID 1 includes the first ECU 632, the second ECU 634, the first sensor 642, the second sensor 644, and optionally the one or more additional first group sensors 646. A second group corresponding to the Group ID 2 includes the first ECU 632, the second ECU 634, the third sensor 652, the fourth sensor 654, and optionally the one or more additional second group sensors 656.

During configuration operations, the vehicle 604 obtains the IVN configuration information for a particular IVN configuration of the IVN system thereof. For example, the vehicle 604 may receive the IVN configuration information from an external device, such as the cloud or server infrastructure 602. In some such examples, the vehicle 604 receives the IVN configuration information OTA from the VAL server 612, the SEAL server 614, or a combination thereof. In other such examples, the vehicle 604 may receive the IVN configuration information from a local device, such as configuration device coupled to the vehicle via a wired connection, such as the port 322 of FIG. 4. As an illustrative example, the VAL server 612 provides information and instructions to the SEAL server 614, and the SEAL server 614 provides the IVN configuration information to the vehicle 604, such as via a SEAL API or APIs. Alternatively, the vehicle 604 may receive the IVN configuration information from a local device via a local wireless connection.

As another example, the vehicle 604 may generate the IVN configuration information locally. To illustrate, the master ECU 622 of the vehicle 604 may generate the IVN configuration information based on IVN setup information or IVN configuration generation information that was received from an external device or devices. Alternatively, the IVN configuration information (e.g., original configuration information) may be preset or pre-programmed during vehicle and/or sensor/ECU manufacture.

After obtaining the IVN configuration information, the IVN configuration information is used to configure the devices of the IVN system. To configure the ECUs and sensors with the obtained IVN configuration information for wireless operations, the vehicle 604 distributes the IVN configuration information (or a respective portion thereof) to ECU and sensors of the IVN system. The vehicle 604 may be configured to distribute the IVN configuration information to the ECU and sensors directly from a single source or in a distributed fashion with one or devices providing the IVN configuration information and/or relaying the IVN configuration information to other devices in a chain or tree-like manner.

In the example illustrated in FIG. 6, the vehicle 604 distributes the IVN configuration information using the master ECU 622, and the master ECU 622 may configure the ECUs and sensors thereof in a unicast or groupcast matter, that is with unicast transmission, groupcast transmission, or a combination thereof. For example, the master ECU 622 may transmit a first groupcast configuration transmission to devices of the first wireless group of the vehicle 604 using a particular VAL Group ID (e.g., Group ID 1). The first groupcast configuration transmission may configure the devices of the first wireless group with the IVN configuration information.

As another example, the master ECU 622 may transmit a first unicast configuration transmission to a particular device of the second wireless group of the vehicle 604 using a particular UE ID (e.g., Sensor 4). The first unicast configuration transmission may configure the particular device (e.g., the third sensor 652) with the IVN configuration information. In some aspects, the configuration transmissions are sent via SEAL APIs from SEAL client to SEAL client of devices within the vehicle 604. After configuration of the IVN system, the vehicle 604 can engage in wireless communications to operate the vehicles 604 and to participate in services or received services from outside devices and entities, such as the VAL server(s).

During transmission operations, the vehicle 604 utilizes the IVN configuration information to transmit internal wireless transmission and/or external wireless transmissions. For example, during vehicle operation the sensors may generate data (e.g., sensor data) and transmit the data to other sensors or ECUs for processing to operate the vehicle 604. To transmit the data (e.g., application data), a particular sensor may transmit a unicast transmission or a groupcast transmission. As an illustrative example, the first sensor 642 may transmit a first data transmission to the second sensor 644 of the first wireless communication group (e.g., Group ID 1) using the VAL User ID corresponding to the second sensor 644, Sensor 2. As another illustrative example, the first sensor 642 may transmit a second data transmission to the third sensor 652 of the second wireless communication group (e.g., Group ID 2) using the VAL User ID corresponding to the third sensor 652, Sensor 4. In some examples where the wireless groups of the IVN configuration are designed such that devices of different groups cannot talk to each other directly, the first sensor 642 transmits the second data transmission to the first ECU 632 (or the second ECU 634) for relay to the third sensor 652 of the second wireless communication group (e.g., Group ID 2) using the VAL User IDs corresponding to both the first ECU 632 and the third sensor 652 because the first ECU 632 is a gateway ECU configured to and capable of talking to devices on both wireless groups.

Additionally, or alternatively, data generated by the vehicle 604 may be transmitted to devices outside of the vehicle. For example, when receiving data from devices outside of the vehicle 604, the external device may utilize the UE and/or Group IDs of the devices of the vehicle 604 to indicate where to route the data. For example, the external devices may include such ID data in the address field of the transmissions. Alternatively, when transmitting data to external devices, the devices of the vehicle 604 may indicate which device (e.g., which ECU or sensor) sent the data using the IVN configuration information.

During dynamic or offline configuration operations (e.g. reconfiguration operations), second IVN configuration information may be obtained which corresponds to a second particular configuration of the IVN system. For example, the second particular configuration of the IVN system may include different unicast and/or groupcast communication links between the devices of the IVN system of the vehicle. To illustrate, the different unicast and/or groupcast communication links may provide better performance in a particular operating mode or responsive to one or more acute or chronic conditions (e.g., transient interference or component failure). The vehicle 604, such as the master ECU 622 thereof, may reconfigure one or more of the ECU and/or sensors thereof with and/or using the second IVN configuration information. The master ECU 622 may also use the IVN configuration information to configure the devices with the second IVN configuration information. For example, the master ECU 622 may use a current or existing piece of information to transmit a unicast or groupcast configuration transmission to adjust the IVN configuration stored at one or more devices of the vehicle 604. To illustrate, the master ECU 622 may transmit a first unicast configuration transmission to the first sensor 642 to switch the first sensor 642 from the first group to the second group. The first unicast configuration transmission may indicate or include the second IVN configuration information (or a portion thereof), such as a new VAL Group ID of Group ID 2, and may be sent based on the (first or original) IVN configuration information (or a portion thereof), such as the original VAL User or UE ID for the first sensor 642. As another example, the master ECU 622 may transmit a first groupcast configuration transmission to the second group of devices to add a group ID for the first group of devices or to switch the second group of devices from the second group to the first group. The first groupcast configuration transmission may indicate or include the second IVN configuration information (or a portion thereof), such as a new VAL Group ID of Group ID 1, and may be sent based on the (first or original) IVN configuration information (or a portion thereof), such as the original VAL Group ID for of Group ID 2.

In some aspects, the vehicle 604 includes a hybrid IVN system with both wired and wireless devices. In such aspects, the vehicle 604, such as the master ECU 622 thereof, may be further configured to control the wired devices of the IVN system. For example, the vehicle 604 may be configured to configure the wired devices and perform wired communications based on the IVN configuration information. To illustrate, when wired devices are part of a group of devices, and/or coupled to a wireless device controlled by the IVN configuration information, the vehicle 604 may utilize the IVN configuration information to configure the wired device for wired communications and may also relay communications to the wired devices via one or more of the wireless devices. For example, the vehicle 604 may utilize a wireless ECU to configure a wired sensor and/or to relay data to and from the wired sensor to the master ECU 622. To illustrate, the VAL server may utilize SEAL APIs to send configuration commands to the wireless ECU for configuration of both wired and wireless sensors thereof.

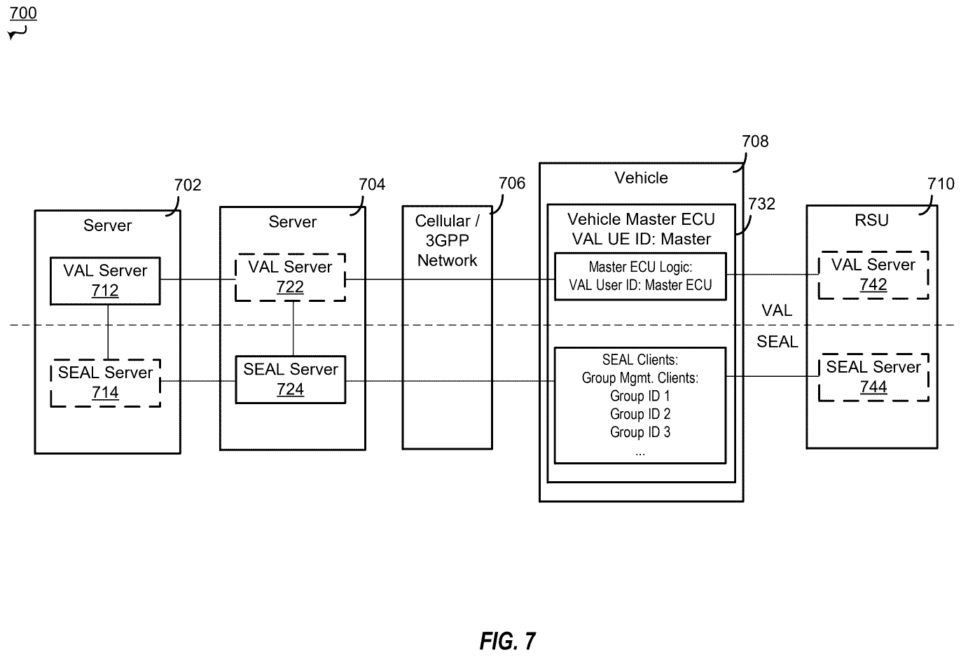

FIG. 7 illustrates a diagram 700 illustrating an example of a system for enhanced IVN configuration operations. In diagram 700, the system includes a first server 702, a second server 704, a cellular network 706, a vehicle 708 including an enhanced wireless or hybrid IVN system, and a road-side unit (RSU) 710. The system illustrated in FIG. 7 illustrates examples of wireless communication links to and from the vehicle 708 and different methods for the vehicle to receive the IVN configuration information when generated by an external device. FIG. 7 also illustrates examples of wireless communications, such as unicast or groupcast data (e.g., application data or VAL data) communications, with external devices based on the received the IVN configuration information.

The first server 702 includes at least a VAL server 712 and optionally includes a SEAL server 714. The second server 704 includes at least a SEAL server 724 and optionally includes a VAL server 722. The VAL and SEAL servers of FIG. 7 may include or correspond to a VAL server and a SEAL server respectively, as described with reference to FIGS. 5A and 6. Although illustrated as separate servers in the example of FIG. 7, the first and second servers 704 may be a single server or collocated in other examples.

The cellular network 706 may include or correspond to the cellular network 506 of FIG. 5A. The first and second servers 702 and 704 are coupled to the vehicle 708 via the cellular network 706. For example, the cellular network 706 provides Uu data links for both application data and configuration data. To illustrate, the cellular network 706 may provide SEAL Uu links for IVN configuration of SEAL entities (devices) of the IVN system of the vehicle 708 or SEAL clients thereof (e.g., SEAL clients of ECUs and sensors).

The vehicle 708 includes a IVN system, such as the enhanced wireless or hybrid IVN system of FIG. 4 or FIG. 6, and may include wireless IVNs or wireless groups of devices, such as sensors and ECUs. The vehicle 708 also includes an IVN configuration device, such as master ECU 732, that is configured to receive and/or generate IVN configuration information, and configured to distribute the IVN configuration information to the devices of the IVN system.

The RSU 710 includes or corresponds to network infrastructure on or near roads to enable cellular and/or V2X communications. The RSU 710 may include a wired or wireless connection to the cellular network 706, such as a backhaul connection. In some such aspects, the RSU 710 may include a connection to, either logically or physically, to a VAL server, a SEAL server 744, or both, such as the VAL and/or SEAL servers of the first and second servers 702 and 704. Additionally, or alternatively, the RSU 710 optionally includes a VAL server 742, a SEAL server 744, or both. The RSU 710 may be configured to couple to the vehicle 708 directly, such as via a sidelink communication link or another D2D communication link, or via the cellular network 706 (e.g., a base station). The RSU 710, such as through a logical or physical connection to external VAL and/or SEAL servers or through its own VAL or SEAL servers 742 and 744, may be configured to provide IVN configuration information to the vehicle 708 for IVN configuration or reconfiguration.

During operation, the vehicle 708 may be configured with first IVN configuration information, such as original or initial IVN configuration information. The first IVN configuration information may be preset or preprogrammed during manufacturing or testing. Alternatively, the first IVN configuration information may be received via a local wireless connection, a wired connection, or OTA. When received wirelessly, such as via a local wireless connection or OTA, the vehicle 708 may receive the first IVN configuration information from remote servers, such as the first server 702, the second server 704, or both. For example, the vehicle 708, such as the master ECU 732 thereof, receives VAL information from one or more of the VAL servers 712 or 722 and receives SEAL information from one or more of the SEAL servers 714 or 724. In some such aspects, the vehicle 708 receives device or unicast related IVN information, such as User and/or UE IDs, from one or more of the VAL servers 712 or 722 and receives group related IVN information, such as Group IDs, from one or more of the SEAL servers 714 or 724. In other such aspects, the vehicle 708 receives unicast and group related IVN information, such as User and/or UE IDs and Group IDs, from one or more of the SEAL servers 714 or 724, such as a based on information or instructions from the VAL server(s) 712, 722.

To configure the devices of the IVN system of the vehicle 708, the master ECU 732 may utilize SEAL APIs to distribute or disseminate the IVN configuration information (or portions thereof) to the individual devices or groups for the IVN system, similar to and as described with reference to FIG. 6.

After initial configuration and setup, the vehicle 708 may operate with the particular IVN configuration for the IVN system of the vehicle 708. For example, the vehicle 708 may utilize VAL or SEAL APIs to perform unicast and groupcast data transmissions. To illustrate, the vehicle 708 may utilize the User, UE, and group IDs of the first IVN configuration information to transmit data transmissions (VAL data transmissions) within the vehicle 708 and to one or more VAL servers external to the vehicle 708. When transmitting data outside of the vehicle 708, the vehicle 708 may transmit vehicle or IVN performance data to enable dynamic configuration (e.g., reconfiguration) of the IVN system of the vehicle 708 or application data to engage in services provided by the VAL and/or SEAL servers of the system.

As an illustrative example, a first sensor of the vehicle 708, such as the first sensor 642 of FIG. 6, may generate first sensor data and wirelessly send the first sensor data to the master ECU 732 directly or via one or more other devices, such as the first ECU 632 of FIG. 6 using the first IVN configuration information. To illustrate, the first sensor 642 may wirelessly transmit a unicast data transmission to the VAL server 712 of the first server 702 utilizing the User or UE IDs of the first IVN configuration information, such as one or more of a first UE ID of the first sensor 642, a second UE ID of the first ECU 632, a third UE ID of the master ECU 622, 732, or a fourth UE ID of the VAL server 712.

As an illustrative example, a device (e.g., a sensor or ECU) or group of the vehicle 708 may receive application data from devices external to the vehicle 708. To illustrate, the VAL server 712 (or 722) may wirelessly transmit application data to the first sensor 642 in a first unicast data transmission or to a first wireless group of the vehicle 708 in a first groupcast data transmission using the first IVN configuration information. The VAL server 712 (or 722) may send the unicast data transmission using a UE or User ID for the first sensor 642 and may send the groupcast data transmit to the first group using the Group ID for the devices of the first group (e.g., the first ECU 632, the first sensor 642, etc.).

From time to time, the system may decide to reconfigure the IVN system of the vehicle 708, such as based on the vehicle performance and/or IVN data. The system may generate and transmit second IVN configuration information to the vehicle 708 in manners similar to the transmissions of the first IVN configuration information to the vehicle 708. For example, the vehicle 708 may receive the second IVN configuration information from one or more of the first and second servers 702 and 704, or from the RSU 710. In a particular example, the vehicle 708 receives the second IVN configuration information from the RSU 710, such as from a VAL or SEAL server thereof, or from the VAL and/or SEAL servers of the one or more of the first and second servers 702 and 704 and via the RSU 710, and optionally the cellular network 706, as an intermediary.

Upon receiving the second IVN configuration information, the vehicle 708 may reconfigure one or more devices of the IVN system to generate new wireless groups and/or unicast paths. The reconfiguring of the IVN system of the vehicle 708 may create one or more new, second unicast and/or groupcast data links that are different from one or more original, first unicast and/or groupcast data links of the first IVN configuration information. To illustrate, some of the original data pipes or paths are changed to generate new data pipes or paths to improve performance, such as to reduce interference, balance bandwidth usage, avoid a failed component, add new functionality, etc.

After the reconfiguration, the vehicle 708 may operate with a second particular IVN configuration for the IVN system of the vehicle 708. For example, the vehicle 708 may utilize VAL or SEAL APIs to perform unicast and groupcast data transmissions with the new, second data link/paths. To illustrate, the vehicle 708 may utilize second User, UE, and group IDs of the second IVN configuration information to transmit second data transmissions (second VAL data transmissions) within the vehicle 708 and to one or more VAL servers external to the vehicle 708. When transmitting data outside of the vehicle 708, the vehicle 708 may transmit vehicle or IVN performance data to enable dynamic configuration (e.g., reconfiguration) for the IVN system of the vehicle 708 or application data to engage in services provided by the VAL and/or SEAL servers of the system.

Although examples of online or network connected operations are illustrated and described in the example of FIG. 7, in other examples, the vehicle 708 may operate in offline or not connected modes as well, such as described with reference to FIG. 6. When operating in offline or not connected modes, the vehicle 708, such as the master ECU 732 thereof, may function as or assume the role of a VAL server, a SEAL server, or both. For example, before or after the external/remote reconfiguration of the vehicle 708 by the system when online or operating in a network connected mode, the vehicle 708 may transition to an offline mode or begin operating in a non-connected mode. During such offline or non-connected operations, the vehicle 708 may generate new IVN configuration information (e.g., third IVN configuration information) based on local criteria, as described with reference to FIG. 6. The local criteria may be set by the system, such as by the VAL or SEAL servers of the first or second servers 702 and/or 704. The vehicle 708 may then configure the devices of the IVN system based on locally generated, third IVN configuration information and operate according to a third particular IVN configuration of the IVN system corresponding to the third IVN configuration information. The configuration operations and the subsequent application data based-operations of the vehicle 708 may be similar to the configuration and application data based operations described with reference to FIG. 6.

Although examples of receiving IVN configuration information via wireless communication are illustrated and described in the example of FIG. 7, in other examples, the vehicle 708 may receive the IVN configuration information from an external device that is coupled to the vehicle by a wired interface, such as via the port 322 of FIG. 4.

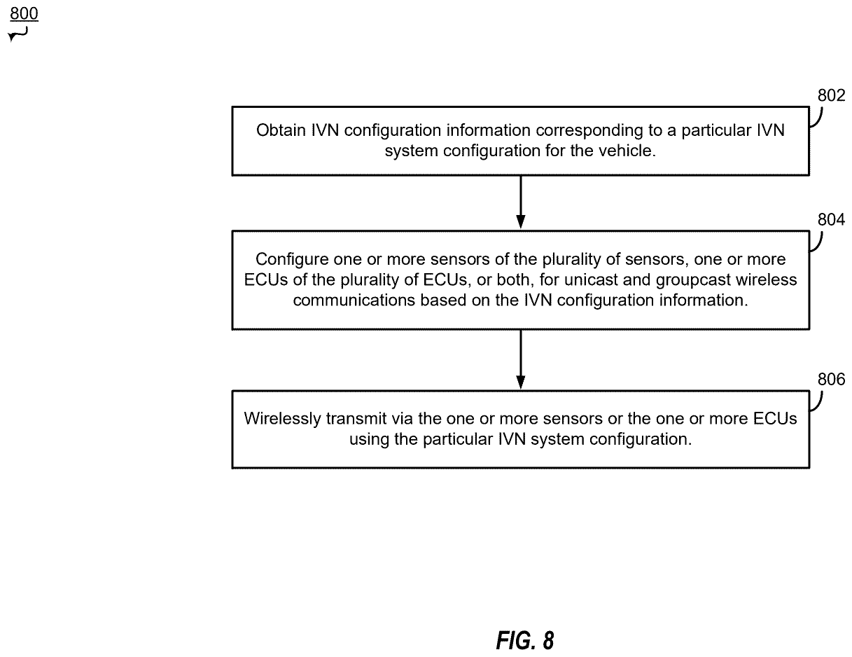

FIG. 8 is a flow diagram 800 illustrating example blocks executed by a wireless communication device (e.g., a UE, an automotive system, or a vehicle) configured according to an aspect of the present disclosure. The example blocks will also be described with respect to vehicle 604 as illustrated in FIG. 9. FIG. 9 is a block diagram illustrating vehicle 604 configured according to one aspect of the present disclosure. Vehicle 604 includes the structure, hardware, and components as illustrated for UE 115 of FIG. 2 and/or vehicle 604 of FIG. 6. For example, vehicle 604 includes controller/processor 280, which operates to execute logic or computer instructions stored in memory 282, as well as controlling the components of vehicle 604 that provide the features and functionality of vehicle 604. Vehicle 604, under control of controller/processor 280, transmits and receives signals via wireless radios 901a-r and antennas 252a-r. Wireless radios 901a-r include various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 9, memory 282 stores IVN configuration logic 902, VAL logic 903, SEAL logic 904, vehicle operations information 905, performance information 906 (e.g., vehicle IVN and/or ECU performance), IVN reconfiguration information 907, and settings data 908 (e.g., IVN settings data). The data (902-908) stored in the memory 282 may include or correspond to the data (e.g., IVN configuration information) stored at the vehicle (e.g., vehicle 604) and devices thereof, as described with reference to FIGS. 4-7.

At block 802, a device, such as a UE, an automotive system, or a vehicle, obtains IVN configuration information corresponding to a particular IVN system configuration for the vehicle. For example, the vehicle 604 (e.g., a UE or an automotive system thereof) may generate IVN configuration information internally, such as by a master ECU, or may receive IVN configuration information from an external device wirelessly or via a wired port, as described with reference to FIGS. 4-7. The IVN configuration information may correspond to original IVN configuration or IVN reconfiguration information. The IVN configuration may optionally include a configuration indication (e.g., indicating a change in configuration from a prior indication) or may include differential information (e.g., only IVN configurations that need to be adjusted or changed) as opposed to full configuration information for each device of the IVN system. The IVN configuration information includes one or more pieces of information configured to enable or adjust unicast and groupcast transmissions for devices of the vehicle 604.

At block 804, the vehicle configures one or more sensors of the plurality of sensors, one or more ECUs of the plurality of ECUs, or both, for unicast and groupcast wireless communications based on the IVN configuration information. For example, the vehicle 604 wireless transmits or receives one or more unicast and groupcast configuration transmissions internally based on the IVN configuration information. To illustrate, a master ECU, such the master ECU 432 of FIG. 4 or the master ECU 622 of FIG. 6, transmits configuration transmissions to one or more devices, ECU and/or sensors of the vehicle, indicating at least a portion of the configuration information (e.g., including one or more of VAL UE IDs, VAL User IDs, or VAL Group IDs). The configuration transmissions may be relayed to devices of the IVN system, by one or more intermediary devices, such as gateway ECUs, wireless sensors coupled to wired sensors, wired sensors coupled to wireless sensors, etc.

At block 806, the vehicle wirelessly transmits via the one or more sensors or the one or more ECUs using the particular IVN system configuration. For example, the vehicle 604 wireless transmits or receives one or more unicast transmissions, one or more groupcast transmissions, or a combination thereof, internally or externally. To illustrate, a sensor may transmit sensor data in a unicast transmission within the vehicle to other sensors and/or ECUs. As another illustration, an ECU may transmit a groupcast transmission within the vehicle with application data. As one illustrative example, the first ECU 632 may transmit a first unicast transmission (e.g., with first ECU or sensor data or with vehicle control data) to the second ECU 634 or the first sensor 642, as described with reference to FIG. 6. As another illustrative example, the second ECU 634 may transmit a first groupcast transmission to the third and fourth sensors 652 and 654, and optionally to the additional sensors 656 of the second group (Group ID 2), as described with reference to FIG. 6. As yet another illustrative example, the first ECU 632 and/or the master ECU 622 may transmit a unicast transmission (e.g., an external transmission) to the server infrastructure 602 (e.g., to the VAL server 612 or the SEAL server 614 thereof) or to another external device, such as another external UE, a RSU (e.g., RSU 710), etc., as described with reference to FIGS. 5-7. The vehicle may also receive transmissions, such as unicast or groupcast transmissions, from other external devices using the particular IVN system configuration, as described with reference to FIGS. 4-7. The particular IVN system configuration may include or correspond to the configured specific unicast and groupcast links of the devices of the vehicle or a desired or target network topology, which may be changed from one IVN system configuration to another IVN system configuration based on operating conditions, component performance, etc. and may also be referred to as a target IVN system configuration

The device (e.g., UE or vehicle) may execute additional blocks (or the device may be configured further to perform additional operations) in other implementations. For example, the device (e.g., the vehicle 604 or the UE 115) may perform one or more operations described above, such as described with reference to FIGS. 4-8. As another example, the device (e.g., the vehicle 604 or the UE 115) may perform one or more aspects as presented below.

Accordingly, wireless communication devices may perform enhanced IVN configuration operations for devices of IVN systems of vehicles. By performing enhanced IVN configuration operations, wireless and hybrid IVN systems may be realized in vehicles to reduce vehicle, cost, weight, and complexity, and to increase fuel economy. Additionally, the enhanced IVN configuration operations described herein also enable network updates and/or real-time performance data to be used to update IVN unicast and groupcast operations, and thus IVN and vehicle performance can be improved or adapt to changes over time.

FIG. 10 is a block diagram illustrating network entity 1000 configured according to one aspect of the present disclosure. Network entity 1000 includes the structure, hardware, and components as illustrated for network node 105 (e.g., a base station, VAL server, SEAL server), UE 115, vehicle 604, and/or cloud or server infrastructure 602 of FIGS. 2 and/or 6. For example, network entity 1000 includes controller/processor 240, which operates to execute logic or computer instructions stored in memory 242, as well as controlling the components of network entity 1000 that provide the features and functionality of network entity 1000. Network entity 1000, under control of controller/processor 240, transmits and receives signals via wireless radios 1001a-t and antennas 234a-t. Wireless radios 1001a-t include various components and hardware, as illustrated in FIG. 2 for network node 105, including modulator/demodulators 232a-t, MIMO detector 236, receive processor 238, transmit processor 220, and TX MIMO processor 230. As illustrated in the example of FIG. 10, memory 242 stores IVN configuration logic 1002, VAL logic 1003, SEAL logic 1004, vehicle operations information 1005, performance information 1006, IVN reconfiguration information 1007, and settings data 1008 (e.g., IVN settings data). The data (1002-1008) stored in the memory 242 may include or correspond to the data (e.g., IVN configuration information) stored at the network that is provided to the vehicle (e.g., vehicle 604) and devices thereof, as described with reference to FIGS. 4-7.

The device (e.g., network entity) may execute additional blocks (or the device may be configured further to perform additional operations) in other implementations. For example, the device (e.g., the network node 105, one or more of the server(s) 602, 702, and/or 704, or the RSU 710 ) may perform one or more operations described above, such as described with reference to FIGS. 4-8. As another example, the device may perform one or more aspects as presented below.

Accordingly, wireless communication devices may perform enhanced IVN configuration operations for devices of IVN systems of vehicles. By performing enhanced IVN configuration operations, wireless and hybrid IVN systems may be realized in vehicles to reduce vehicle, cost, weight, and complexity, and to increase fuel economy. Additionally, the enhanced IVN configuration operations described herein also enable network updates and/or real-time performance data to be used to update IVN unicast and groupcast operations, and thus IVN and vehicle performance can be improved or adapt to changes over time.

In a first aspect, an apparatus (e.g., an automotive system) for wireless communication at a vehicle includes: a plurality of sensors; a plurality of electronic control units (ECUs), wherein the plurality of sensors and the plurality of ECUs correspond to a plurality of in-vehicle networks (IVNs) of an IVN system; at least one processor; and a memory coupled to the at least one processor. The at least one processor is configured to cause the apparatus to: obtain IVN configuration information corresponding to a particular IVN system configuration for the vehicle; configure one or more sensors of the plurality of sensors, one or more ECUs of the plurality of ECUs, or both, for unicast and groupcast wireless communications based on the IVN configuration information; and wirelessly transmit unicast and groupcast transmissions via the one or more sensors or the one or more ECUs using the particular IVN system configuration. In some such aspects, wirelessly transmitting via the one or more sensors or the one or more ECUs using the particular IVN system configuration includes transmitting one or more first unicast transmissions, one or more first groupcast transmissions, or a combination thereof.

In a second aspect, alone or in combination with the first aspect, the IVN configuration information includes a unique device identifier, a configurable unicast identifier and one or more configuration groupcast identifiers.

In a third aspect, alone or in combination with one or more of the above aspects, the IVN configuration information includes User ID information, User Equipment (UE) ID information, and Group ID information.

In a fourth aspect, alone or in combination with one or more of the above aspects, the User ID information identifies a particular sensor or ECU of the plurality of sensors or plurality of ECUs, wherein the UE ID information identifies a particular UE associated with the particular sensor or ECU for transmitting or receiving transmissions, and wherein the Group ID information identifies one or more groups associated with the particular sensor or ECU.

In a fifth aspect, alone or in combination with one or more of the above aspects, a particular group of the one or more groups includes a set of sensors comprising an existing vehicle wired network, a set of wireless groups comprising multiple, wired networks of a same bus type, or a set of ECUs associated with a group configuration.

In a sixth aspect, alone or in combination with one or more of the above aspects, the processor is further configured to cause the apparatus to: receive second IVN configuration information from a SEAL server, the second IVN configuration corresponding to a second particular IVN system configuration for the vehicle; reconfigure the one or more sensors of the plurality of sensors, the one or more ECUs of the plurality of ECUs, or both, based on the second IVN configuration information; and wirelessly transmit second unicast transmissions, second groupcast transmissions, or a combination thereof, using the second particular IVN system configuration.

In a seventh aspect, alone or in combination with one or more of the above aspects, the processor is further configured to cause the apparatus to: generate, at a master ECU of the plurality of ECUs, second IVN configuration information based on the IVN configuration information and vehicle operational information when the vehicle is not connected to a SEAL server, the second IVN configuration corresponding to a second particular IVN system configuration for the vehicle; reconfigure the one or more sensors of the plurality of sensors, the one or more ECUs of the plurality of ECUs, or both, based on the second IVN configuration information; and wirelessly transmit second unicast transmissions, second groupcast transmissions, or a combination thereof, using the second particular IVN system configuration.

In an eighth aspect, alone or in combination with one or more of the above aspects, the processor is further configured to cause the apparatus to: determine, at the master ECU, to generate the second IVN configuration information and to reconfigure the IVN configuration information with the second IVN configuration information responsive to determination of a sensor failure, determination of an ECU failure, determination of interference exceeding an interference threshold, determination of switching a vehicle mode or service area, or receipt of IVN reconfiguration parameters.

In a ninth aspect, alone or in combination with one or more of the above aspects, the processor configured to cause the apparatus to configure one or more sensors of the plurality of sensors, one or more ECUs of the plurality of ECUs, or both, for unicast and groupcast wireless communications based on the IVN configuration information includes to: configure a first sensor of the plurality of sensors with first UE ID information of the IVN configuration information corresponding to a UE ID for the first sensor; and configure a first group of sensors of the plurality of sensors with first group ID information of the IVN configuration information corresponding to a Group ID for the first group of sensors.

In a tenth aspect, alone or in combination with one or more of the above aspects, configuring the first sensor corresponds to establishing an original configuration of the first sensor or adjusting a prior configuration of the first sensor.

In an eleventh aspect, alone or in combination with one or more of the above aspects, configuring the first sensor causes the first sensor to switch from second UE ID information to the first UE ID information, and wherein switching from the second UE ID information to the first UE ID information establishes new internal unicast data links to and from the first sensor within the vehicle and new external unicast data links to and from the first sensor from an external server.

In a twelfth aspect, alone or in combination with one or more of the above aspects, configuring the first group sensors causes at least one sensor of the first group of sensors to switch from second group ID information to the first group ID information, to add the first group ID information, or to remove other group ID information other than the first group ID information.

In a thirteenth aspect, alone or in combination with one or more of the above aspects, switching from the second group ID information to the first group ID information establishes new internal groupcast data links to the first group of sensors within the vehicle and new external groupcast data links to the first group of sensors from an external server.

In a fourteenth aspect, alone or in combination with one or more of the above aspects, the processor configured to cause the apparatus to configure a first sensor of the plurality of sensors with first UE ID information of the IVN configuration information corresponding to a UE ID for the first sensor includes to: determine to configure the first sensor of the plurality of sensors with the first UE ID information of the IVN configuration information based on first user ID information of the IVN configuration information, a configuration indicator, or both, the first user ID information corresponding to a user ID for the first sensor associated with the first UE ID information; and transmit a first UE ID configuration message indicating the first UE ID information of the IVN configuration information and configured to cause the first sensor to change UE ID information.

In a fifteenth aspect, alone or in combination with one or more of the above aspects, the processor configured to cause the apparatus to configure a first group of sensors of the plurality of sensors with first group ID information of the IVN configuration information corresponding to a Group ID for the first group of sensors includes to: determine to configure the first group of sensors with the first group ID information of based on a plurality of user ID information of the IVN configuration information, configuration indicators, or a combination thereof, the plurality of user ID information corresponding to a user ID for each sensor of the first group of sensors and associated with the first group ID information; and transmit, to the first group of sensors of the plurality of sensors, a first group ID configuration message indicating the first group ID information of the IVN configuration information and configured to cause at least one sensor of the first group of sensors to change group ID information.

In a sixteenth aspect, alone or in combination with one or more of the above aspects, the processor is further configured to configure the first group of sensors of the plurality of sensors with the first group ID information of the IVN configuration information includes to: transmit, from a master ECU to the first group of sensors of the plurality of sensors, a first group ID configuration message indicating the first group ID information of the IVN configuration information and configured to cause at least one sensor of the first group of sensors to change group ID information.

In a seventeenth aspect, alone or in combination with one or more of the above aspects, the processor is further configured to configure the first group of sensors of the plurality of sensors with the first group ID information of the IVN configuration includes to: transmit, from a master ECU to the first sensor, a first UE ID configuration message indicating the first UE ID information of the IVN configuration information and configured to cause the first sensor to change UE ID information.

In an eighteenth aspect, alone or in combination with one or more of the above aspects, the processor is further configured to: transmit, from a master ECU to a second sensor, a second UE ID configuration message indicating second UE ID information of the IVN configuration information and configured to cause the second sensor to change second UE ID information.

In a nineteenth aspect, alone or in combination with one or more of the above aspects, the processor is further configured to: transmit, from a master ECU to the first sensor or a first ECU, a second UE ID configuration message indicating second UE ID information of the IVN configuration information for a second sensor; and relay, from the first sensor or the first ECU to the second sensor, the second UE ID configuration message indicating the second UE ID information of the IVN configuration information and configured to cause the second sensor to change the second UE ID information.

In a twentieth aspect, alone or in combination with one or more of the above aspects, the IVN configuration information enables unicast and groupcast transmissions within the vehicle, unicast transmissions to and from external devices, and groupcast transmissions from external devices.

In a twenty-first aspect, alone or in combination with one or more of the above aspects, the processor is further configured to cause the apparatus to wirelessly transmit includes to: transmit a first unicast transmission from a first sensor of the plurality of sensors to a second sensor of the plurality of sensors using first UE ID information of the IVN configuration information corresponding to a UE ID for the second sensor; and transmit first groupcast transmissions from a first ECU to a first group of sensors using first Group ID information of the IVN configuration information corresponding to a group ID for the first group of sensors. In other aspects, the vehicle may only transmit unicast transmissions or may only transmit groupcast communications.

In a twenty-second aspect, alone or in combination with one or more of the above aspects, the processor is further configured to cause the apparatus to wirelessly transmit includes to: transmit a first unicast transmission from a first sensor of the plurality of sensors to an external device; and receive a second unicast transmission from an external device for a second sensor of the plurality of sensors indicating second UE ID information of the IVN configuration information corresponding to a UE ID for the second sensor.

In a twenty-third aspect, alone or in combination with one or more of the above aspects, the processor is further configured to cause the apparatus to wirelessly transmit includes to: receive a first groupcast transmissions from an external device for a first group of devices of the vehicle and indicating first Group ID information of the IVN configuration information; and relay the first groupcast transmissions to devices of the first group of devices based on the first Group ID information corresponding to a group ID for the first group of devices.

In a twenty-fourth aspect, alone or in combination with one or more of the above aspects, the IVN configuration information is received from a first server, and wherein the processor is further configured to cause the apparatus to: receive first application data from a second server separate from the first server; and transmit second application data to the second server.

In a twenty-fifth aspect, alone or in combination with one or more of the above aspects, the processor is further configured to cause the apparatus to: receive a first portion of the IVN configuration information from a first server; and receive a second portion of the IVN configuration information from a second server separate from the first server.

In a twenty-sixth aspect, alone or in combination with one or more of the above aspects, the IVN configuration information includes VAL User ID information, VAL User Equipment (UE) ID information, VAL Service ID information and VAL Group ID information.

In a twenty-seventh aspect, alone or in combination with one or more of the above aspects, the VAL Service ID information includes local VAL service ID information assigned to wireless or wired groups managed by SEAL, global VAL service ID information assigned to overall vehicle or to wired and wireless networks thereof, and wherein the VAL group ID information is assigned to a group of devices on a particular bus.

In a twenty-eighth aspect, alone or in combination with one or more of the above aspects, the plurality of ECUs include a master ECU and multiple gateways ECUs, wherein the master ECU is configured to receive the IVN configuration from a SEAL server via a SEAL API, and wherein the master ECU is configured to provide the IVN configuration to one or of the gateway ECUs and to one or more of sensors of the plurality of sensors.

In a twenty-ninth aspect, alone or in combination with one or more of the above aspects, the IVN includes a plurality of wired networks and a plurality of wireless networks, wherein the plurality of wireless networks includes a Wi-Fi network, a Bluetooth network, a cellular network, wherein the plurality of wired network includes a CAN bus, a FLEXRay bus, a LVDS bus, a LIN bus, a MOST bus, a USB bus, an ethernet BUS, and wherein each wired network of the plurality of wired networks and each wireless network of the plurality of wireless networks may include one or more groups of devices.

In a thirtieth aspect, alone or in combination with one or more of the above aspects, to obtain the IVN configuration information includes to: receive the IVN configuration information via a cellular connection; receive the IVN configuration information via a local wireless connection; receive the IVN configuration information via a wired connection; or generate, at a master ECU of the vehicle, the IVN configuration information.

In a thirty-first aspect, alone or in combination with one or more of the above aspects, the IVN configuration information includes unicast and groupcast information for both wireless communications and wired communications in-vehicle.

In a thirty-second aspect, alone or in combination with one or more of the above aspects, the processor is further configured to cause the apparatus to configure the one or more sensors includes to: transmit a portion of the IVN configuration information for a first wired sensor of the plurality of sensors wirelessly to a first wireless sensor or ECU in a wireless unicast or groupcast transmission, wherein the first wired sensor and the first wireless sensor or ECU are part a same wireless group; and transmit, from the first wireless sensor or ECU to the first wired sensor, the portion of the IVN configuration information for the first wired sensor via a wired connection.

In a thirty-third aspect, alone or in combination with one or more of the above aspects, a method of wireless communication at a vehicle or an apparatus thereof includes: obtaining IVN configuration information corresponding to a particular in-vehicle networks (IVN) system configuration for an IVN system of the vehicle including a plurality of IVNs; configuring one or more sensors of a plurality of sensors of the IVN system, one or more ECUs of a plurality of ECUs of the IVN system, or both, for unicast and groupcast wireless communications based on the IVN configuration information; and wirelessly transmitting via the one or more sensors or the one or more ECUs using the particular IVN system configuration.

In an additional aspect of the disclosure, a vehicle includes a plurality of sensors, a plurality of electronic control units (ECUs), wherein the plurality of sensors and the plurality of ECUs correspond to a plurality of in-vehicle networks (IVNs) of an IVN system, at least one processor, and a memory coupled to the at least one processor. The at least one processor is configured to cause the vehicle to: obtain IVN configuration information corresponding to a particular IVN system configuration for the vehicle; configure one or more sensors of the plurality of sensors, one or more ECUs of the plurality of ECUs, or both, for unicast and groupcast wireless communications based on the IVN configuration information; and wirelessly transmit unicast and groupcast transmissions via the one or more sensors or the one or more ECUs using the particular IVN system configuration.

In an additional aspect of the disclosure, a vehicle includes a plurality of sensors, a plurality of electronic control units (ECUs), wherein the plurality of sensors and the plurality of ECUs correspond to a plurality of in-vehicle networks (IVNs) of an IVN system, at least one processor, and a memory coupled to the at least one processor. The at least one processor is configured to cause the vehicle to: obtain IVN configuration information corresponding to a particular IVN system configuration for the vehicle; configure one or more sensors of the plurality of sensors, one or more ECUs of the plurality of ECUs, or both, for unicast and groupcast wireless communications based on the IVN configuration information; and wirelessly transmit groupcast transmissions via the one or more sensors or the one or more ECUs using the particular IVN system configuration.

In an additional aspect of the disclosure, a vehicle includes a plurality of sensors, a plurality of electronic control units (ECUs), wherein the plurality of sensors and the plurality of ECUs correspond to a plurality of in-vehicle networks (IVNs) of an IVN system, at least one processor, and a memory coupled to the at least one processor. The at least one processor is configured to cause the vehicle to: obtain IVN configuration information corresponding to a particular IVN system configuration for the vehicle; configure one or more sensors of the plurality of sensors, one or more ECUs of the plurality of ECUs, or both, for unicast and groupcast wireless communications based on the IVN configuration information; and wirelessly transmit unicast transmissions via the one or more sensors or the one or more ECUs using the particular IVN system configuration.

In an additional aspect of the disclosure, a vehicle includes: a plurality of sensors; a plurality of electronic control units (ECUs), wherein the plurality of sensors and the plurality of ECUs correspond to a plurality of in-vehicle networks (IVNs) of an IVN system; at least one processor; and a memory coupled to the at least one processor. The at least one processor is configured to cause the vehicle to: obtain IVN configuration information corresponding to a particular IVN system configuration for the vehicle; configure one or more sensors of the plurality of sensors, one or more ECUs of the plurality of ECUs, or both, for unicast and groupcast wireless communications based on the IVN configuration information; and wirelessly transmit unicast and groupcast transmissions via the one or more sensors or the one or more ECUs using the particular IVN system configuration. In some such aspects, wirelessly transmitting via the one or more sensors or the one or more ECUs using the particular IVN system configuration includes transmitting one or more first unicast transmissions, one or more first groupcast transmissions, or a combination thereof.

In an additional aspect of the disclosure, an apparatus for wireless communication at a vehicle includes: means for in-vehicle communication including a plurality of means for sensing and a plurality of means for controlling electronics; means for processing; and means for storing electronic data coupled to the means for processing, wherein the means for processing is configured to cause the apparatus to: obtain IVN configuration information corresponding to a particular IVN system configuration for the vehicle; configure one or more means for sensing of the plurality of means for sensing, one or more means for controlling electronics of the plurality of means for controlling electronics, or both, for unicast and groupcast wireless communications based on the IVN configuration information; and wirelessly transmit via the one or more means for sensing or the one or more means for controlling electronics using the particular IVN system configuration.

In an additional aspect of the disclosure, a non-transitory computer readable medium stores instructions that, when executed by a processor, cause the processor to perform operations. The operations include: obtaining IVN configuration information corresponding to a particular in-vehicle networks (IVN) system configuration for an IVN system of the vehicle including a plurality of IVNs; configuring one or more sensors of a plurality of sensors of the IVN system, one or more ECUs of a plurality of ECUs of the IVN system, or both, for unicast and groupcast wireless communications based on the IVN configuration information; and wirelessly transmitting via the one or more sensors or the one or more ECUs using the particular IVN system configuration.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-10 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus for wireless communication at a vehicle, comprising:
a plurality of sensors;
a plurality of electronic control units (ECUs), wherein the plurality of sensors and the plurality of ECUs correspond to a plurality of in-vehicle networks (IVNs) of an IVN system;
at least one processor; and
a memory coupled to the at least one processor,
wherein the at least one processor is configured to cause the apparatus to:
obtain IVN configuration information corresponding to a particular IVN system configuration for the vehicle;
configure one or more sensors of the plurality of sensors, one or more ECUs of the plurality of ECUs, or both, for unicast and groupcast wireless communications based on the IVN configuration information; and
wirelessly transmit via the one or more sensors or the one or more ECUs using the particular IVN system configuration.

2. The apparatus of claim 1, wherein the IVN configuration information includes a unique device identifier, a configurable unicast identifier and one or more configuration groupcast identifiers.

3. The apparatus of claim 1, wherein the IVN configuration information includes User ID information, User Equipment (UE) ID information, and Group ID information.

4. The apparatus of claim 3, wherein the User ID information identifies a particular sensor or ECU of the plurality of sensors or plurality of ECUs, wherein the UE ID information identifies a particular UE associated with the particular sensor or ECU for transmitting or receiving transmissions, and wherein the Group ID information identifies one or more groups associated with the particular sensor or ECU.

5. The apparatus of claim 4, wherein a particular group of the one or more groups includes a set of sensors comprising an existing vehicle wired network, a set of wireless groups comprising multiple, wired networks of a same bus type, or a set of ECUs associated with a group configuration.

6. The apparatus of claim 1, wherein the processor is further configured to cause the apparatus to:
receive second IVN configuration information from a Service Enabler Architecture Layer (SEAL) server, the second IVN configuration corresponding to a second particular IVN system configuration for the vehicle;
reconfigure the one or more sensors of the plurality of sensors, the one or more ECUs of the plurality of ECUs, or both, based on the second IVN configuration information; and
wirelessly transmit second unicast transmissions, second groupcast transmissions, or a combination thereof, using the second particular IVN system configuration.

7. The apparatus of claim 1, wherein the processor is further configured to cause the apparatus to:
generate, at a master ECU of the plurality of ECUs, second IVN configuration information based on the IVN configuration information and vehicle operational information when the vehicle is not connected to a SEAL server, the second IVN configuration corresponding to a second particular IVN system configuration for the vehicle;
reconfigure the one or more sensors of the plurality of sensors, the one or more ECUs of the plurality of ECUs, or both, based on the second IVN configuration information; and
wirelessly transmit second unicast transmissions, second groupcast transmissions, or a combination thereof, using the second particular IVN system configuration.

8. The apparatus of claim 7, wherein the processor is further configured to cause the apparatus to:
determine, at the master ECU, to generate the second IVN configuration information and to reconfigure the IVN configuration information with the second IVN configuration information responsive to determination of a sensor failure, determination of an ECU failure, determination of interference exceeding an interference threshold, determination of switching a vehicle mode or service area, or receipt of IVN reconfiguration parameters.

9. The apparatus of claim 1, wherein the processor configured to cause the apparatus to configure the one or more sensors of the plurality of sensors, the one or more ECUs of the plurality of ECUs, or both, for the unicast and groupcast wireless communications based on the IVN configuration information includes to:
configure a first sensor of the plurality of sensors with first UE ID information of the IVN configuration information corresponding to a UE ID for the first sensor; and
configure a first group of sensors of the plurality of sensors with first group ID information of the IVN configuration information corresponding to a Group ID for the first group of sensors.

10. The apparatus of claim 9, wherein to configure the first sensor corresponds to establishing an original configuration of the first sensor or adjusting a prior configuration of the first sensor.

11. The apparatus of claim 9, wherein to configure the first sensor causes the first sensor to switch from second UE ID information to the first UE ID information, and wherein switching from the second UE ID information to the first UE ID information establishes new internal unicast data links to and from the first sensor within the vehicle and new external unicast data links to and from the first sensor from an external server.

12. The apparatus of claim 9, wherein to configure the first group of sensors causes at least one sensor of the first group of sensors to switch from second group ID information to the first group ID information, to add the first group ID information, or to remove other group ID information other than the first group ID information.

13. The apparatus of claim 12, wherein to switch from the second group ID information to the first group ID information establishes new internal groupcast data links to the first group of sensors within the vehicle and new external groupcast data links to the first group of sensors from an external server.

14. The apparatus of claim 9, wherein the processor configured to cause the apparatus to configure the first sensor of the plurality of sensors with the first UE ID information of the IVN configuration information corresponding to a UE ID for the first sensor includes to:
determine to configure the first sensor of the plurality of sensors with the first UE ID information of the IVN configuration information based on first user ID information of the IVN configuration information, a configuration indicator, or both, the first user ID information corresponding to a user ID for the first sensor associated with the first UE ID information; and
transmit a first UE ID configuration message indicating the first UE ID information of the IVN configuration information and configured to cause the first sensor to change UE ID information.

15. The apparatus of claim 9, wherein the processor configured to cause the apparatus to configure the first group of sensors of the plurality of sensors with the first group ID information of the IVN configuration information corresponding to the Group ID for the first group of sensors includes to:
determine to configure the first group of sensors with the first group ID information of based on a plurality of user ID information of the IVN configuration information, configuration indicators, or a combination thereof, the plurality of user ID information corresponding to a user ID for each sensor of the first group of sensors and associated with the first group ID information; and
transmit, to the first group of sensors of the plurality of sensors, a first group ID configuration message indicating the first group ID information of the IVN configuration information and configured to cause at least one sensor of the first group of sensors to change group ID information.

16. The apparatus of claim 9, wherein the processor is further configured to configure the first group of sensors of the plurality of sensors with the first group ID information of the IVN configuration information includes to:
transmit, from a master ECU to the first group of sensors of the plurality of sensors, a first group ID configuration message indicating the first group ID information of the IVN configuration information and configured to cause at least one sensor of the first group of sensors to change group ID information.

17. The apparatus of claim 9, wherein the processor is further configured to configure the first group of sensors of the plurality of sensors with the first group ID information of the IVN configuration includes to:
transmit, from a master ECU to the first sensor, a first UE ID configuration message indicating the first UE ID information of the IVN configuration information and configured to cause the first sensor to change UE ID information.

18. The apparatus of claim 17, wherein the processor is further configured to:
transmit, from the master ECU to a second sensor, a second UE ID configuration message indicating second UE ID information of the IVN configuration information and configured to cause the second sensor to change second UE ID information.

19. The apparatus of claim 17, wherein the processor is further configured to:
transmit, from a master ECU to the first sensor or a first ECU, a second UE ID configuration message indicating second UE ID information of the IVN configuration information for a second sensor; and
relay, from the first sensor or the first ECU to the second sensor, the second UE ID configuration message indicating the second UE ID information of the IVN configuration information and configured to cause the second sensor to change the second UE ID information.

20. The apparatus of claim 1, wherein the IVN configuration information enables unicast and groupcast transmissions within the vehicle, unicast transmissions to and from external devices, and groupcast transmissions from the external devices.

21. The apparatus of claim 1, wherein the processor is further configured to cause the apparatus to wirelessly transmit includes to:
transmit a first unicast transmission from a first sensor of the plurality of sensors to a second sensor of the plurality of sensors using first UE ID information of the IVN configuration information corresponding to a UE ID for the second sensor; and
transmit a first groupcast transmission from a first ECU to a first group of sensors using first Group ID information of the IVN configuration information corresponding to a group ID for the first group of sensors.

22. The apparatus of claim 1, wherein the processor is further configured to cause the apparatus to wirelessly transmit includes to:
transmit a first unicast transmission from a first sensor of the plurality of sensors to an external device; and
receive a second unicast transmission from the external device for a second sensor of the plurality of sensors indicating second UE ID information of the IVN configuration information corresponding to a UE ID for the second sensor.

23. The apparatus of claim 1, wherein the processor is further configured to cause the apparatus to wirelessly transmit includes to:
receive a first groupcast transmissions from an external device for a first group of devices of the vehicle and indicating first Group ID information of the IVN configuration information; and
relay the first groupcast transmissions to devices of the first group of devices based on the first Group ID information corresponding to a group ID for the first group of devices.

24. The apparatus of claim 1, wherein the IVN configuration information is received from a first server, and wherein the processor is further configured to cause the apparatus to:
receive first application data from a second server separate from the first server; and
transmit second application data to the second server.

25. The apparatus of claim 1, wherein the processor is further configured to cause the apparatus to:
receive a first portion of the IVN configuration information from a first server; and
receive a second portion of the IVN configuration information from a second server separate from the first server.

26. The apparatus of claim 1, wherein the IVN configuration information includes VAL User ID information, VAL User Equipment (UE) ID information, VAL Service ID information and VAL Group ID information.

27. The apparatus of claim 26, wherein the VAL Service ID information includes local VAL service ID information assigned to wireless or wired groups managed by SEAL, global VAL service ID information assigned to overall vehicle or to wired and wireless networks thereof, and wherein the VAL group ID information is assigned to a group of devices on a particular bus.

28. The apparatus of claim 1, wherein the plurality of ECUs include a master ECU and multiple gateways ECUs, wherein the master ECU is configured to receive the IVN configuration from a SEAL server via a SEAL application programming interface (API), and wherein the master ECU is configured to provide the IVN configuration to one or of the gateway ECUs and to one or more of sensors of the plurality of sensors.

29. The apparatus of claim 1, wherein the IVN system includes a plurality of wired networks and a plurality of wireless networks, wherein the plurality of wireless networks includes a Wi-Fi network, a Bluetooth network, a cellular network, wherein the plurality of wired network includes a Controller Area Network (CAN) bus, a FLEXRay bus, a low-voltage differential signaling (LVDS) bus, a Local Interconnect Network (LIN) bus, a Media Oriented Systems Transport (MOST) bus, a universal serial bus (USB) bus, an ethernet bus, and wherein each wired network of the plurality of wired networks and each wireless network of the plurality of wireless networks may include one or more groups of devices.

30. The apparatus of claim 1, wherein to obtain the IVN configuration information includes to:
receive the IVN configuration information via a cellular connection;
receive the IVN configuration information via a local wireless connection;
receive the IVN configuration information via a wired connection; or
generate, at a master ECU of the vehicle, the IVN configuration information.

31. The apparatus of claim 1, wherein the IVN configuration information includes unicast and groupcast information for both wireless communications and wired communications in-vehicle.

32. The apparatus of claim 1, wherein the processor is further configured to cause the apparatus to configure the one or more sensors includes to:
transmit a portion of the IVN configuration information for a first wired sensor of the plurality of sensors wirelessly to a first wireless sensor or ECU in a wireless unicast or groupcast transmission, wherein the first wired sensor and the first wireless sensor or ECU are part a same wireless group; and
transmit, from the first wireless sensor or ECU to the first wired sensor, the portion of the IVN configuration information for the first wired sensor via a wired connection.

33. A method of wireless communication at a vehicle includes:
obtaining IVN configuration information corresponding to a particular in-vehicle networks (IVN) system configuration for an IVN system of the vehicle including a plurality of IVNs;
configuring one or more sensors of a plurality of sensors of the IVN system, one or more ECUs of a plurality of ECUs of the IVN system, or both, for unicast and groupcast wireless communications based on the IVN configuration information; and
wirelessly transmitting via the one or more sensors or the one or more ECUs using the particular IVN system configuration.
